(19) United States
(12) Patent Application Publication
(10) Pub. No.: US 2026/0229892 A1
(43) Pub. Date: Aug. 6, 2026

(54) COMPREHENSIVE CONTROL METHOD AND APPARATUS FOR POWER FLUCTUATION-STABILIZING ENERGY STORAGE SYSTEM, AND DEVICE

(71) Applicant: ELECTRIC POWER RESEARCH INSTITUTE. CHINA SOUTHERN POWER GRID, Guangzhou (CN)

(72) Inventors: Zhiyu MAO, Guangzhou (CN); Chen LI, Guangzhou (CN); Min XU, Guangzhou (CN); Siming HE, Guangzhou (CN); Tong LIU, Guangzhou (CN); Jian SUN, Guangzhou (CN); Zhenyu MAO, Guangzhou (CN); Shuyin DUAN, Guangzhou (CN); Lvzerui YUAN, Guangzhou (CN); Yipeng LIU, Guangzhou (CN); Yangxin QIU, Guangzhou (CN)

(73) Assignee: ELECTRIC POWER RESEARCH INSTITUTE. CHINA SOUTHERN POWER GRID, Guangzhou (CN)

(21) Appl. No.: 19/149,236

(22) PCT Filed: Apr. 11, 2024
(86) PCT No.: PCT/CN2024/087152

§ 371 Date: Jul. 18, 2025

(30) Foreign Application Priority Data
Sep. 8, 2023 (CN) 202311157852.7

(51) Int. Cl. H02J 3/0014; H02J 3/32; H02J 3/38; H02J 101/28; H02J 103/30

(52) U.S. Cl. CPC H02J 3/0014; H02J 3/32; H02J 3/381; H02J 2101/28; H02J 2103/30

(57) ABSTRACT

An integrated energy storage system of new energy power transmission includes an integrated energy storage module. In the method, stabilizing power is calculated by means of empirical modal decomposition, so that the energy storage rated power requirement and the operational burden of the integrated energy storage system of new energy power transmission can be reduced in the operation of grid-connected power corresponding to the stabilizing power. An energy storage integrated control mode is used to control the integrated energy storage module to operate at an optimal depth of discharge, so that the cycle life of the integrated energy storage module is fully utilized, and the service life of the integrated energy storage module is prolonged, thereby solving the technical problems of low system operational efficiency and short service life of energy storage elements thereof in power fluctuation stabilizing processes of existing new energy power transmission systems.

### CROSS-REFERENCE TO RELATED APPLICATIONS

This application is a national phase application of international patent application No. PCT/CN2024/087152, filed on Apr. 11, 2024, which claims priority to Chinese patent application No. 202311157852.7, entitled “COMPREHENSIVE CONTROL METHOD AND APPARATUS FOR POWER FLUCTUATION-STABILIZING ENERGY STORAGE SYSTEM, AND DEVICE” and filed with the China Patent Office on Sep. 8, 2023, the entire contents of which are incorporated herein by reference.

### TECHNICAL FIELD

The present disclosure relates to the technical field of energy storage systems, and in particular, to a comprehensive control method and apparatus for a power fluctuation-stabilizing energy storage system, and a device.

### BACKGROUND

Under the background of “carbon peak and carbon neutrality”, renewable energy represented by wind power has developed rapidly in recent years. The wind power is random and fluctuating, which will pose challenges to safe and stable operation of a power system during grid connection of renewable energy. Therefore, configuration of energy storage systems for renewable energy to alleviate power fluctuations at grid connection points has become a current research hotspot.

In consideration of relatively high costs of current energy storage systems, in case of application to power fluctuation-stabilizing scenarios, main factors affecting economic feasibility mainly include energy storage capacity configuration, operational energy loss, life loss, and the like. In terms of capacity configuration and operational energy loss of the energy storage system, a project is mainly configured according to an energy storage ratio, it is mainly determined by a maximum power requirement of the energy storage system, that is, energy storage rated power, and the energy storage system is configured to offset a difference between grid-connected power and the wind power. Therefore, under the premise of meeting a requirement for fluctuation mitigation, enabling smoothed grid-connected power to track power well can effectively reduce the energy storage rated power and simultaneously lower the operational energy loss of the energy storage system. Currently, there is no good technical solution to meet the above requirements. In addition, during stabilizing of wind power fluctuations, frequent charge-discharge switching of an energy storage element (such as a battery) in the energy storage system may affect the operating life thereof. Although there is a dual-battery energy storage operation method based on an independent charging/discharging mode, which effectively reduces the impact and prolongs the service life, and through data analysis, it is determined that an optimal depth of discharge for prolonging the life is 0.8, that is, a state of charge (SOC) range of the energy storage element is 0.1 to 0.9, the mode is extremely sensitive to charge-discharge energy imbalance. Typically, two energy storage elements cannot operate at the optimal depth of discharge, resulting in insufficient utilization of the cycle life.

### SUMMARY

Embodiments of the present disclosure provide a comprehensive control method and apparatus for a power fluctuation-stabilizing energy storage system, and a device, to solve the technical problems of low system operational efficiency and short service life of energy storage elements thereof in power fluctuation stabilizing processes of existing new energy power transmission systems.

To achieve the foregoing objective, the embodiments of the present disclosure provide the following technical solutions.

In one aspect, a comprehensive control method for a power fluctuation-stabilizing energy storage system is provided, applied to an integrated energy storage system of new energy power transmission, the integrated energy storage system of new energy power transmission including an integrated energy storage module, wherein the comprehensive control method includes the following steps:
acquiring a topological structure diagram, a total power of generation, and an initial value of modal decomposition order of the integrated energy storage system of new energy power transmission, constructing a grid-connected power mathematical model according to the topological structure diagram, and adding I Gaussian white noises to the total power of generation to construct a power data set including I pieces of data;
calculating a first-order modal component and initial energy storage power by using a first-order modal decomposition calculation rule according to the initial value of modal decomposition order, and inputting the initial energy storage power into the grid-connected power mathematical model to obtain initial fluctuation rates corresponding to the first-order modal component at two time scales;
if the initial fluctuation rates at the two time scales meet a constraint condition, taking the initial energy storage power as stabilizing power of the integrated energy storage system of new energy power transmission;
if the initial fluctuation rates at the two time scales do not meet the constraint condition, updating the modal decomposition order; calculating an order modal component and energy storage power by using a k^{th} modal decomposition calculation rule according to the modal decomposition order; and inputting the energy storage power into the grid-connected power mathematical model to obtain updated fluctuation rates corresponding to the order modal component at the two time scales until the updated fluctuation rates meet the constraint condition, and taking energy storage power corresponding to the updated fluctuation rates meeting the constraint condition as the stabilizing power of the integrated energy storage system of new energy power transmission; and
controlling, by using an energy storage integrated control mode, the integrated energy storage module to store the stabilizing power.

Optionally, the integrated energy storage module includes a first energy storage element, a second energy storage element, and a third energy storage element, and content of the energy storage integrated control mode includes:
acquiring parameter data of the integrated energy storage module, the parameter data including a rated charging power, a rated discharging power, a rated energy storage power, a rated energy storage capacity, a charging/discharging upper limit, a charging/discharging lower limit, operating efficiency parameters, and a power control cycle;
calculating a charging power, a discharging power, a remaining charging capacity of energy storage, and a remaining discharging capacity of energy storage of the integrated energy storage module according to the parameter data; and
controlling the first energy storage element, the second energy storage element, and the third energy storage element to store the stabilizing power by switching between thirteen operating conditions according to the charging/discharging upper limit, the charging/discharging lower limit, the charging power, and the discharging power;
the thirteen operating conditions including a first operating condition, a second operating condition, a third operating condition, a fourth operating condition, a fifth operating condition, a sixth operating condition, a seventh operating condition, an eighth operating condition, a ninth operating condition, a tenth operating condition, an eleventh operating condition, a twelfth operating condition, and a thirteenth operating condition.

Optionally, the controlling the first energy storage element, the second energy storage element, and the third energy storage element to store the stabilizing power by switching between the thirteen operating conditions according to the charging/discharging upper limit, the charging/discharging lower limit, the charging power, and the discharging power includes:
when the integrated energy storage module is in the first operating condition, acquiring a first stored power amount of the first energy storage element charged at the charging power and a first remaining power amount of the second energy storage element discharged at the discharging power; if the first stored power amount reaches the charging/discharging upper limit, the integrated energy storage module switching to the second operating condition; and if the first remaining power amount reaches the charging/discharging lower limit, the integrated energy storage module switching to the third operating condition;
when the integrated energy storage module is in the second operating condition, acquiring a second stored power amount of the third energy storage element charged at the charging power and a second remaining power amount of the second energy storage element discharged at the discharging power; if the second stored power amount reaches the charging/discharging upper limit, the integrated energy storage module switching to the fifth operating condition; and if the second remaining power amount reaches the charging/discharging lower limit, the integrated energy storage module switching to the fourth operating condition;
when the integrated energy storage module is in the third operating condition, acquiring a third stored power amount of the first energy storage element charged at the charging power and a third remaining power amount of the third energy storage element discharged at the discharging power; if the third stored power amount reaches the charging/discharging upper limit, the integrated energy storage module switching to the sixth operating condition; and if the third remaining power amount reaches the charging/discharging lower limit, the integrated energy storage module switching to the seventh operating condition;
when the integrated energy storage module is in the fourth operating condition, acquiring a fourth stored power amount of the third energy storage element charged at the charging power and a fourth remaining power amount of the first energy storage element discharged at the discharging power; if the fourth stored power amount reaches the charging/discharging upper limit, the integrated energy storage module switching to the fifth operating condition; and if the fourth remaining power amount reaches the charging/discharging lower limit, the integrated energy storage module switching to the eighth operating condition;
when the integrated energy storage module is in the fifth operating condition, acquiring a fifth stored power amount of the second energy storage element charged at the charging power and a fifth remaining power amount of the first energy storage element discharged at the discharging power; if the fifth stored power amount reaches the charging/discharging upper limit, the integrated energy storage module switching to the ninth operating condition; and if the fifth remaining power amount reaches the charging/discharging lower limit, the integrated energy storage module switching to the eighth operating condition;
when the integrated energy storage module is in the sixth operating condition, acquiring a sixth stored power amount of the second energy storage element charged at the charging power and a sixth remaining power amount of the third energy storage element discharged at the discharging power; if the sixth stored power amount reaches the charging/discharging upper limit, the integrated energy storage module switching to the tenth operating condition; and if the sixth remaining power amount reaches the charging/discharging lower limit, the integrated energy storage module switching to the seventh operating condition;
when the integrated energy storage module is in the seventh operating condition, acquiring a seventh stored power amount of the second energy storage element charged at the charging power and a seventh remaining power amount of the first energy storage element discharged at the discharging power; if the seventh stored power amount reaches the charging/discharging upper limit, the integrated energy storage module switching to the tenth operating condition; and if the seventh remaining power amount reaches the charging/discharging lower limit, the integrated energy storage module switching to the eleventh operating condition;
when the integrated energy storage module is in the eighth operating condition, acquiring an eighth stored power amount of the second energy storage element charged at the charging power and an eighth remaining power amount of the third energy storage element discharged at the discharging power; if the eighth stored power amount reaches the charging/discharging upper limit, the integrated energy storage module switching to the ninth operating condition; and if the eighth remaining power amount reaches the charging/discharging lower limit, the integrated energy storage module switching to the twelfth operating condition;
when the integrated energy storage module is in the ninth operating condition, acquiring a ninth stored power amount of the first energy storage element charged at the charging power and a ninth remaining power amount of the third energy storage element discharged at the discharging power; if the ninth stored power amount reaches the charging/discharging upper limit, the integrated energy storage module switching to the second operating condition; and if the ninth remaining power amount reaches the charging/discharging lower limit, the integrated energy storage module switching to the twelfth operating condition;
when the integrated energy storage module is in the tenth operating condition, acquiring a tenth stored power amount of the third energy storage element charged at the charging power and a tenth remaining power amount of the first energy storage element discharged at the discharging power; if the tenth stored power amount reaches the charging/discharging upper limit, the integrated energy storage module switching to the thirteenth operating condition; and if the tenth remaining power amount reaches the charging/discharging lower limit, the integrated energy storage module switching to the eleventh operating condition;
when the integrated energy storage module is in the eleventh operating condition, acquiring an eleventh remaining power amount of the second energy storage element discharged at the discharging power and an eleventh stored power amount of the third energy storage element charged at the discharging power; if the eleventh remaining power amount reaches the charging/discharging lower limit, the integrated energy storage module switching to the third operating condition; and if the eleventh stored power amount reaches the charging/discharging upper limit, the integrated energy storage module switching to the thirteenth operating condition;
when the integrated energy storage module is in the twelfth operating condition, acquiring a twelfth stored power amount of the first energy storage element charged at the charging power and a twelfth remaining power amount of the second energy storage element discharged at the discharging power; if the twelfth stored power amount reaches the charging/discharging upper limit, the integrated energy storage module switching to the second operating condition; and if the twelfth remaining power amount reaches the charging/discharging lower limit, the integrated energy storage module switching to the fourth operating condition; and
when the integrated energy storage module is in the thirteenth operating condition, acquiring a thirteenth stored power amount of the first energy storage element charged at the charging power and a thirteenth remaining power amount of the second energy storage element discharged at the discharging power; if the thirteenth stored power amount reaches the charging/discharging upper limit, the integrated energy storage module switching to the sixth operating condition; and if the thirteenth remaining power amount reaches the charging/discharging lower limit, the integrated energy storage module switching to the third operating condition.

Optionally, content of the first-order modal decomposition calculation rule includes:
performing a calculation based on the power data set and the total power of generation by using a first residual operator formula, to obtain the first-order modal component; and
taking the first-order modal component as the initial energy storage power;
the first residual operator formula being:

$${P}_{IMF 1} = {P}_{w} - \frac{1}{I} {\sum }_{I = 1}^{I} M ( {P}_{w} + {w}_{i} ) , i = 1 , 2 , … , I$$

where P_{IMF1} denotes the first-order modal component, P_{w} denotes the total power of generation, wᵢ denotes the i^{th} Gaussian white noise, M(*) denotes a residual operator, and I denotes a total quantity of Gaussian white noises.

Optionally, content of the k^{th} modal decomposition calculation rule includes:
performing empirical modal decomposition (EMD) on the total power of generation according to the modal decomposition order, to obtain an order residual corresponding to the modal decomposition order;
adding the I Gaussian white noises to the order residual to construct a residual data set including I pieces of data;
performing a calculation based on the residual data set and a k−1^{th} order residual by using a second residual operator formula, to obtain the order modal component; and
performing a calculation based on all the order modal components by using an energy storage power calculation formula, to obtain energy storage power of first k orders;
the second residual operator formula being:

$${P}_{IMFk} = {P}_{RESk - 1} - \frac{1}{I} {\sum }_{i = 1}^{I} M ( {P}_{RESk} + {w}_{i} ) ;$$

the energy storage power calculation formula being: P_{BESS}=P_{IMF1}+P_{IMF2}+ . . . +P_{IMFk}
where P_{IMFk} denotes a k^{th}-order order modal component, P_{RESk} denotes a k^{th}-order order residual, wᵢ denotes the i^{th} Gaussian white noise, M(*) denotes a residual operator, I denotes a total quantity of Gaussian white noises, and P_{BESS} denotes the energy storage power of the first k orders.

Optionally, the grid-connected power mathematical model includes a power expression and a fluctuation rate expression, the power expression being:

$${P}_{g} ( t ) = {\sum }_{l = 1}^{n} {P}_{w l} ( t ) + {P}_{BESS} ( t ) .$$

the fluctuation rate expression being:

$${P}_{1} ( t ) = [ max {P}_{g} ( a ) - min {P}_{g} ( b ) ] / {P}_{w , rate}$$

$$a , b = t - 60 / {k}_{t} , t - ( 60 - {k}_{t} ) / {k}_{t} , … , t ;$$

$${P}_{10} ( t ) = [ max {P}_{g} ( a ) - min {P}_{g} ( b ) ] / {P}_{w , rate}$$

$$a , b = t - 600 / {k}_{t} , t - ( 600 - {k}_{t} ) / {k}_{t} , … , t$$

where P_{g}(t) denotes grid-connected power at time t, P_{wl}(t) denotes power outputted by an l^{th} generator unit at time t, P_{BESS}(t) denotes energy storage power at time t, n denotes a total number of generator units in the integrated energy storage system of new energy power transmission, P₁(t) denotes a fluctuation rate at a 1-min time scale at time t, P₁₀(t) denotes a fluctuation rate at a 10-min time scale at time t, P_{w, rate} denotes an installed capacity of a power plant in the integrated energy storage system of new energy power transmission, kₜ denotes a sampling interval, and a and b both denote sampling time.

Optionally, the constraint condition is P₁∈[0, 1/10] and P₁₀∈[0, ⅓], P₁ being a fluctuation rate at a 1-min time scale, and P₁₀ being a fluctuation rate at a 10-min time scale.

In another aspect, a comprehensive control apparatus for a power fluctuation-stabilizing energy storage system is provided, applied to an integrated energy storage system of new energy power transmission, the integrated energy storage system of new energy power transmission including an integrated energy storage module, wherein the comprehensive control apparatus includes a data acquisition module, an initial calculation module, a first judgment module, a second judgment module, and a control storage module.

The data acquisition module is configured to acquire a topological structure diagram, a total power of generation, and an initial value of modal decomposition order of the integrated energy storage system of new energy power transmission, construct a grid-connected power mathematical model according to the topological structure diagram, and add I Gaussian white noises to the total power of generation to construct a power data set including I pieces of data.

The initial calculation module is configured to calculate a first-order modal component and initial energy storage power by using a first-order modal decomposition calculation rule according to the initial value of modal decomposition order, and input the initial energy storage power into the grid-connected power mathematical model to obtain initial fluctuation rates corresponding to the first-order modal component at two time scales.

The first judgment module is configured to, if the initial fluctuation rates at the two time scales meet a constraint condition, take the initial energy storage power as stabilizing power of the integrated energy storage system of new energy power transmission.

The second judgment module is configured to, if the initial fluctuation rates at the two time scales do not meet the constraint condition, update the modal decomposition order; calculate an order modal component and energy storage power by using a k^{th} modal decomposition calculation rule according to the modal decomposition order; and input the energy storage power into the grid-connected power mathematical model to obtain updated fluctuation rates corresponding to the order modal component at the two time scales until the updated fluctuation rates meet the constraint condition, and take energy storage power corresponding to the updated fluctuation rates meeting the constraint condition as the stabilizing power of the integrated energy storage system of new energy power transmission.

The control storage module is configured to control, by using an energy storage integrated control mode, the integrated energy storage module to store the stabilizing power.

Optionally, the integrated energy storage module includes a first energy storage element, a second energy storage element, and a third energy storage element, and content of the energy storage integrated control mode includes:
acquiring parameter data of the integrated energy storage module, the parameter data including a rated charging power, a rated discharging power, a rated energy storage power, a rated energy storage capacity, a charging/discharging upper limit, a charging/discharging lower limit, operating efficiency parameters, and a power control cycle;
calculating a charging power, a discharging power, a remaining charging capacity of energy storage, and a remaining discharging capacity of energy storage of the integrated energy storage module according to the parameter data; and
controlling the first energy storage element, the second energy storage element, and the third energy storage element to store the stabilizing power by switching between thirteen operating conditions according to the charging/discharging upper limit, the charging/discharging lower limit, the charging power, and the discharging power;
the thirteen operating conditions including a first operating condition, a second operating condition, a third operating condition, a fourth operating condition, a fifth operating condition, a sixth operating condition, a seventh operating condition, an eighth operating condition, a ninth operating condition, a tenth operating condition, an eleventh operating condition, a twelfth operating condition, and a thirteenth operating condition;
when the integrated energy storage module is in the first operating condition, acquiring a first stored power amount of the first energy storage element charged at the charging power and a first remaining power amount of the second energy storage element discharged at the discharging power; if the first stored power amount reaches the charging/discharging upper limit, the integrated energy storage module switching to the second operating condition; and if the first remaining power amount reaches the charging/discharging lower limit, the integrated energy storage module switching to the third operating condition;
when the integrated energy storage module is in the second operating condition, acquiring a second stored power amount of the third energy storage element charged at the charging power and a second remaining power amount of the second energy storage element discharged at the discharging power; if the second stored power amount reaches the charging/discharging upper limit, the integrated energy storage module switching to the fifth operating condition; and if the second remaining power amount reaches the charging/discharging lower limit, the integrated energy storage module switching to the fourth operating condition;
when the integrated energy storage module is in the third operating condition, acquiring a third stored power amount of the first energy storage element charged at the charging power and a third remaining power amount of the third energy storage element discharged at the discharging power; if the third stored power amount reaches the charging/discharging upper limit, the integrated energy storage module switching to the sixth operating condition; and if the third remaining power amount reaches the charging/discharging lower limit, the integrated energy storage module switching to the seventh operating condition;
when the integrated energy storage module is in the fourth operating condition, acquiring a fourth stored power amount of the third energy storage element charged at the charging power and a fourth remaining power amount of the first energy storage element discharged at the discharging power; if the fourth stored power amount reaches the charging/discharging upper limit, the integrated energy storage module switching to the fifth operating condition; and if the fourth remaining power amount reaches the charging/discharging lower limit, the integrated energy storage module switching to the eighth operating condition;
when the integrated energy storage module is in the fifth operating condition, acquiring a fifth stored power amount of the second energy storage element charged at the charging power and a fifth remaining power amount of the first energy storage element discharged at the discharging power; if the fifth stored power amount reaches the charging/discharging upper limit, the integrated energy storage module switching to the ninth operating condition; and if the fifth remaining power amount reaches the charging/discharging lower limit, the integrated energy storage module switching to the eighth operating condition;
when the integrated energy storage module is in the sixth operating condition, acquiring a sixth stored power amount of the second energy storage element charged at the charging power and a sixth remaining power amount of the third energy storage element discharged at the discharging power; if the sixth stored power amount reaches the charging/discharging upper limit, the integrated energy storage module switching to the tenth operating condition; and if the sixth remaining power amount reaches the charging/discharging lower limit, the integrated energy storage module switching to the seventh operating condition;
when the integrated energy storage module is in the seventh operating condition, acquiring a seventh stored power amount of the second energy storage element charged at the charging power and a seventh remaining power amount of the first energy storage element discharged at the discharging power; if the seventh stored power amount reaches the charging/discharging upper limit, the integrated energy storage module switching to the tenth operating condition; and if the seventh remaining power amount reaches the charging/discharging lower limit, the integrated energy storage module switching to the eleventh operating condition;
when the integrated energy storage module is in the eighth operating condition, acquiring an eighth stored power amount of the second energy storage element charged at the charging power and an eighth remaining power amount of the third energy storage element discharged at the discharging power; if the eighth stored power amount reaches the charging/discharging upper limit, the integrated energy storage module switching to the ninth operating condition; and if the eighth remaining power amount reaches the charging/discharging lower limit, the integrated energy storage module switching to the twelfth operating condition;
when the integrated energy storage module is in the ninth operating condition, acquiring a ninth stored power amount of the first energy storage element charged at the charging power and a ninth remaining power amount of the third energy storage element discharged at the discharging power; if the ninth stored power amount reaches the charging/discharging upper limit, the integrated energy storage module switching to the second operating condition; and if the ninth remaining power amount reaches the charging/discharging lower limit, the integrated energy storage module switching to the twelfth operating condition;
when the integrated energy storage module is in the tenth operating condition, acquiring a tenth stored power amount of the third energy storage element charged at the charging power and a tenth remaining power amount of the first energy storage element discharged at the discharging power; if the tenth stored power amount reaches the charging/discharging upper limit, the integrated energy storage module switching to the thirteenth operating condition; and if the tenth remaining power amount reaches the charging/discharging lower limit, the integrated energy storage module switching to the eleventh operating condition;
when the integrated energy storage module is in the eleventh operating condition, acquiring an eleventh remaining power amount of the second energy storage element discharged at the discharging power and an eleventh stored power amount of the third energy storage element charged at the discharging power; if the eleventh remaining power amount reaches the charging/discharging lower limit, the integrated energy storage module switching to the third operating condition; and if the eleventh stored power amount reaches the charging/discharging upper limit, the integrated energy storage module switching to the thirteenth operating condition;
when the integrated energy storage module is in the twelfth operating condition, acquiring a twelfth stored power amount of the first energy storage element charged at the charging power and a twelfth remaining power amount of the second energy storage element discharged at the discharging power; if the twelfth stored power amount reaches the charging/discharging upper limit, the integrated energy storage module switching to the second operating condition; and if the twelfth remaining power amount reaches the charging/discharging lower limit, the integrated energy storage module switching to the fourth operating condition; and
when the integrated energy storage module is in the thirteenth operating condition, acquiring a thirteenth stored power amount of the first energy storage element charged at the charging power and a thirteenth remaining power amount of the second energy storage element discharged at the discharging power; if the thirteenth stored power amount reaches the charging/discharging upper limit, the integrated energy storage module switching to the sixth operating condition; and if the thirteenth remaining power amount reaches the charging/discharging lower limit, the integrated energy storage module switching to the third operating condition.

In yet another aspect, a terminal device is provided, including a processor and a memory;
the memory being configured to store program code and transmit the program code to the processor; and
the processor being configured to perform, according to instructions in the program code, the comprehensive control method for the power fluctuation-stabilizing energy storage system above.

In the comprehensive control method and apparatus for the power fluctuation-stabilizing energy storage system, and the device, the method includes acquiring a topological structure diagram, a total power of generation, and an initial value of modal decomposition order of the integrated energy storage system of new energy power transmission, constructing a grid-connected power mathematical model according to the topological structure diagram, and adding I Gaussian white noises to the total power of generation to construct a power data set including I pieces of data; calculating a first-order modal component and initial energy storage power by using a first-order modal decomposition calculation rule according to the initial value of modal decomposition order, and inputting the initial energy storage power into the grid-connected power mathematical model to obtain initial fluctuation rates corresponding to the first-order modal component at two time scales; if the initial fluctuation rates at the two time scales meet a constraint condition, taking the initial energy storage power as stabilizing power of the integrated energy storage system of new energy power transmission; if the initial fluctuation rates at the two time scales do not meet the constraint condition, updating the modal decomposition order; calculating an order modal component and energy storage power by using a k^{th} modal decomposition calculation rule according to the modal decomposition order; and inputting the energy storage power into the grid-connected power mathematical model to obtain updated fluctuation rates corresponding to the order modal component at the two time scales until the updated fluctuation rates meet the constraint condition, and taking energy storage power corresponding to the updated fluctuation rates meeting the constraint condition as the stabilizing power of the integrated energy storage system of new energy power transmission; and controlling, by using an energy storage integrated control mode, the integrated energy storage module to store the stabilizing power. As can be seen from the above technical solution, the embodiments of the present disclosure have the following advantages: in the comprehensive control method for the power fluctuation-stabilizing energy storage system, stabilizing power is calculated by means of EMD, so that the energy storage rated power requirement and the operational burden of the integrated energy storage system of new energy power transmission can be reduced in the operation of grid-connected power corresponding to the stabilizing power. An energy storage integrated control mode is used to control the integrated energy storage module to operate at an optimal depth of discharge, so that the cycle life of the integrated energy storage module is fully utilized, and the service life of the integrated energy storage module is prolonged, thereby solving the technical problems of low system operational efficiency and short service life of energy storage elements thereof in power fluctuation stabilizing processes of existing new energy power transmission systems.

### BRIEF DESCRIPTION OF THE DRAWINGS

In order to more clearly illustrate the technical solutions in embodiments of the present disclosure or the prior art, the accompanying drawings used in the description of the embodiments or the prior art will be briefly introduced below. It is apparent that, the accompanying drawings in the following description are only some embodiments of the present disclosure, and other drawings can be obtained by those of ordinary skill in the art from the provided drawings without creative efforts.

FIG. 1 is a flowchart of steps of a comprehensive control method for a power fluctuation-stabilizing energy storage system according to embodiments of the present disclosure;

FIG. 2 is a schematic diagram of a framework of an integrated energy storage system of new energy power transmission in the comprehensive control method for the power fluctuation-stabilizing energy storage system according to embodiments of the present disclosure;

FIG. 3 is a flowchart of the comprehensive control method for the power fluctuation-stabilizing energy storage system according to embodiments of the present disclosure;

FIG. 4a is a diagram of a first-order mode during decomposition of the flowchart of the comprehensive control method for the power fluctuation-stabilizing energy storage system according to embodiments of the present disclosure;

FIG. 4b is a diagram of a second-order mode during decomposition of the flowchart of the comprehensive control method for the power fluctuation-stabilizing energy storage system according to embodiments of the present disclosure;

FIG. 4c is a diagram of a third-order mode during decomposition of the flowchart of the comprehensive control method for the power fluctuation-stabilizing energy storage system according to embodiments of the present disclosure;

FIG. 4d is a diagram of a fourth-order mode during decomposition of the flowchart of the comprehensive control method for the power fluctuation-stabilizing energy storage system according to embodiments of the present disclosure;

FIG. 5 is a graph of a total power of generation before and after smoothing by means of ensemble EMD and the comprehensive control method for the power fluctuation-stabilizing energy storage system according to embodiments of the present disclosure;

FIG. 6a is a graph of energy storage power by means of ensemble EMD and the comprehensive control method for the power fluctuation-stabilizing energy storage system according to embodiments of the present disclosure;

FIG. 6b is a frequency domain diagram of energy storage power by means of ensemble EMD and the comprehensive control method for the power fluctuation-stabilizing energy storage system according to embodiments of the present disclosure;

FIG. 7 is a graph of a total power of generation before and after smoothing by using different control methods;

FIG. 8a is a graph of energy storage power after first-order high-pass filtering;

FIG. 8b is a graph of energy storage power under the comprehensive control method for the power fluctuation-stabilizing energy storage system according to embodiments of the present disclosure;

FIG. 9 shows charge-discharge energy imbalance under different control methods;

FIG. 10a is a power output diagram of a first energy storage element in the comprehensive control method for the power fluctuation-stabilizing energy storage system according to embodiments of the present disclosure;

FIG. 10b is a power output diagram of a second energy storage element in the comprehensive control method for the power fluctuation-stabilizing energy storage system according to embodiments of the present disclosure;

FIG. 10c is a power output diagram of a third energy storage element in the comprehensive control method for the power fluctuation-stabilizing energy storage system according to embodiments of the present disclosure;

FIG. 11 is a diagram of SOC of individual parts in a conventional dual-battery integrated energy storage system;

FIG. 12 is a diagram of SOC of energy storage elements in the comprehensive control method for the power fluctuation-stabilizing energy storage system according to embodiments of the present disclosure; and

FIG. 13 is a flowchart of a framework of a comprehensive control apparatus for a power fluctuation-stabilizing energy storage system according to embodiments of the present disclosure.

### DETAILED DESCRIPTION

In order to make the above invention objectives, features, and advantages of the present disclosure more obvious and understandable, the technical solutions in the embodiments of the present disclosure will be described clearly and completely below with reference to the accompanying drawings in the embodiments of the present disclosure. Obviously, the described embodiments are merely some of rather than all of the embodiments of the present disclosure. All other embodiments acquired by those of ordinary skill in the art without creative efforts based on the embodiments of the present disclosure shall fall within the protection scope of the present disclosure.

In the description of the embodiments of the present disclosure, the terms “first” and “second” are used for descriptive purposes only, which cannot be construed as indicating or implying a relative importance, or implicitly specifying the number of the indicated technical features. Therefore, the features defined with “first” and “second” may explicitly or implicitly include one or more features. In the description of the embodiments of the present disclosure, “a plurality of” means two or more, unless otherwise defined explicitly and specifically.

In the embodiments of the present disclosure, unless otherwise specified and defined explicitly, the terms “mount”, “connect”, “join”, and “fix” should be understood in a broad sense, which may be, for example, a fixed connection, a detachable connection, or an integral connection; a mechanical connection or an electrical connection; or a direct connection, an indirect connection via an intermediate medium, an internal connection between two elements, or interaction between two elements. Those of ordinary skill in the art can understand specific meanings of these terms in the present disclosure according to specific situations.

Embodiments of the present disclosure provide a comprehensive control method and apparatus for a power fluctuation-stabilizing energy storage system, and a device, to solve the technical problems of low system operational efficiency and short service life of energy storage elements thereof in power fluctuation stabilizing processes of existing new energy power transmission systems in a manner of dual-layer control. According to the comprehensive control method and apparatus for the power fluctuation-stabilizing energy storage system, and the device, in outer-layer control of the manner of dual-layer control, ensemble EMD is taken as a computational basis for power stabilizing, and advantages of a signal processing method are used to maintain phase synchronization between smoothed grid-connected power and a total power of generation, i.e., well track the total power of generation, enhancing a local total power of generation resolution capability through improvements thereof, thereby reducing an energy storage rated power requirement and an operational burden. In inner-layer control of the manner of dual-layer control, the use of an energy storage integrated control mode endows each energy storage element with a different charge/discharge characteristic, enhances robustness against energy imbalance, and enables each energy storage element to operate at an optimal depth of discharge, so that the cycle life of the integrated energy storage module is fully utilized, and the service life of the integrated energy storage module is prolonged. The comprehensive control method and apparatus for the power fluctuation-stabilizing energy storage system, and the device are applied to any power fluctuation-stabilizing scenario in a power grid that requires frequent charge-discharge switching of energy storage, for example, new energy fluctuation scenarios such as photovoltaic fluctuations and tie-line power fluctuations. In the comprehensive control method and apparatus for the power fluctuation-stabilizing energy storage system, and the device, an energy storage integrated control mode is more widely applicable and is applicable to scenarios where frequent charge-discharge switching of energy storage is required, such as photovoltaic fluctuations, tie-line power fluctuations, and power grid frequency regulation. In this embodiment, new energy of a wind farm is used as an example for description.

### Embodiment I

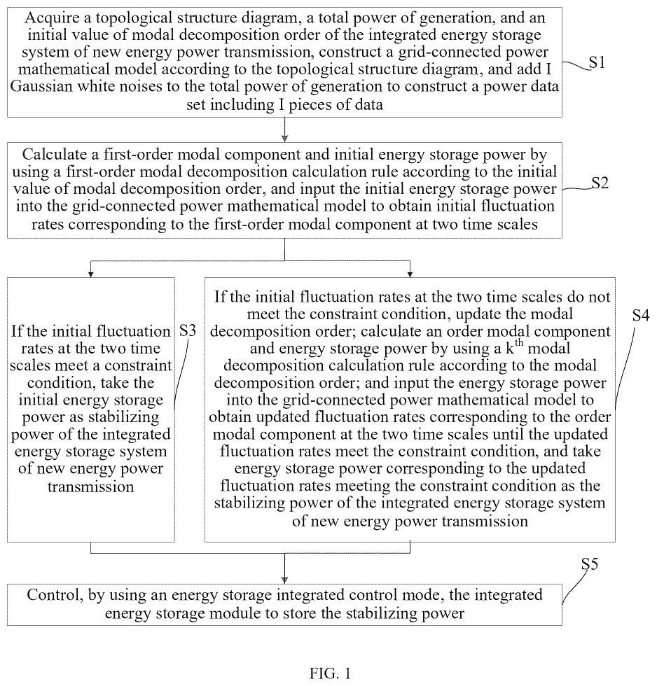

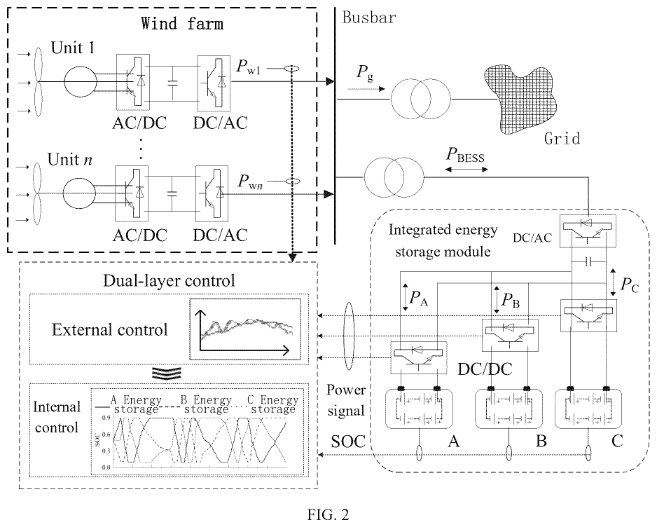

FIG. 1 is a flowchart of steps of a comprehensive control method for a power fluctuation-stabilizing energy storage system according to embodiments of the present disclosure, and FIG. 2 is a schematic diagram of a framework of an integrated energy storage system of new energy power transmission in the comprehensive control method for the power fluctuation-stabilizing energy storage system according to embodiments of the present disclosure.

As shown in FIG. 1 and FIG. 2, embodiments of the present disclosure provide a comprehensive control method for a power fluctuation-stabilizing energy storage system, applied to an integrated energy storage system of new energy power transmission, and the integrated energy storage system of new energy power transmission includes an integrated energy storage module.

It is to be noted that, as shown in FIG. 2, the integrated energy storage system of new energy power transmission includes a grid-connected busbar and a wind farm, a power grid, and an integrated energy storage module that are connected to the grid-connected busbar. The integrated energy storage module includes a first energy storage element A, a second energy storage element B, and a third energy storage element C. A direction towards the grid-connected busbar is taken as a positive direction, and a sum of wind power and energy storage power is taken as final grid-connected power. The wind farm includes n generator units.

As shown in FIG. 1, the comprehensive control method for the power fluctuation-stabilizing energy storage system includes the following steps:

In S1, a topological structure diagram, a total power of generation, and an initial value of modal decomposition order of the integrated energy storage system of new energy power transmission are acquired, and a grid-connected power mathematical model is constructed according to the topological structure diagram; and I Gaussian white noises are added to the total power of generation to construct a power data set including I pieces of data.

It is to be noted that in step S1, data is acquired, and based on the acquired data, the grid-connected power mathematical model and the power data set are constructed. In this embodiment, the grid-connected power mathematical model constructed is a standard grid-connected mathematical model constructed based on 1-min and 10-min time scale grid-connected active power change limits and topological structure diagrams in National Standard GB/T 19963.1-2021 Technical Requirements for Connecting Wind Farm to Power System—Part 1: Onshore Wind Power.

In the embodiments of the present disclosure, the initial value of modal decomposition order k=1, and/Gaussian white noises are added to the total power of generation P_{w} to construct a power data set

$${P}_{w}^{i} = {P}_{w} + {w}_{i} ,$$

where i=1, 2 . . . , and I, and wᵢ denotes an i^{th} Gaussian white noise.

In the embodiments of the present disclosure, the grid-connected power mathematical model includes a power expression and a fluctuation rate expression, the power expression is:

$${P}_{g} ( t ) = {\sum }_{l = 1}^{n} {P}_{w l} ( t ) + {P}_{BESS} ( t ) .$$

The fluctuation rate expression is:

$${P}_{1} ( t ) = [ max {P}_{g} ( a ) - min {P}_{g} ( b ) ] / {P}_{w , rate}$$

$$a , b = t - 60 / {k}_{t} , t - ( 60 - {k}_{t} ) / {k}_{t} , … , t ; and$$

$${P}_{10} ( t ) = [ max {P}_{g} ( a ) - min {P}_{g} ( b ) ] / {P}_{w , rate}$$

$$a , b = t - 600 / {k}_{t} , t - ( 600 - {k}_{t} ) / {k}_{t} , … , t$$

where P_{g}(t) denotes grid-connected power at time t, P_{wl}(t) denotes power outputted by an l^{th} generator unit at time t, P_{BESS}(t) denotes energy storage power at time t, n denotes a total number of generator units in the integrated energy storage system of new energy power transmission, P₁(t) denotes a fluctuation rate at a 1-min time scale at time t, P₁₀(t) denotes a fluctuation rate at a 10-min time scale at time t, P_{w, rate} denotes an installed capacity of a power plant in the integrated energy storage system of new energy power transmission, kₜ denotes a sampling interval, and a and b both denote sampling time.

It is to be noted that a and b are both sampling points corresponding to any sampling time in a period on the right side of the equal sign.

In S2, a first-order modal component and initial energy storage power are calculated by using a first-order modal decomposition calculation rule according to the initial value of modal decomposition order; and the initial energy storage power is inputted into the grid-connected power mathematical model to obtain initial fluctuation rates corresponding to the first-order modal component at two time scales.

It is to be noted that, in step S2, a first-order modal component P_{IMF1} and initial energy storage power that correspond to the initial value of modal decomposition order are calculated by using the first-order modal decomposition calculation rule according to the initial value of modal decomposition order. A difference between the total power of generation and an ensemble average of residual operators through EMD is taken as the first-order modal component P_{IMF1}. Under the initial value of modal decomposition order, values of the initial energy storage power and the first-order modal component are the same. Then, the obtained initial energy storage power and a total power of generation are inputted into the grid-connected power mathematical model to calculate an initial grid-connected power of the integrated energy storage system of new energy power transmission, and in the fluctuation rate expression of the grid-connected power mathematical model, initial fluctuation rates at two time scales are calculated according to the initial grid-connected power.

In S3, if the initial fluctuation rates at the two time scales meet a constraint condition, the initial energy storage power is taken as stabilizing power of the integrated energy storage system of new energy power transmission.

It is to be noted that, in step S3, when the initial fluctuation rates obtained according to step S2 meet the constraint condition, the initial energy storage power is taken as the stabilizing power of the integrated energy storage system of new energy power transmission, so that grid-connected power in this case meets grid-connected power required by the integrated energy storage system of new energy power transmission. In this embodiment, the constraint condition is P₁∈[0, 1/10] and P₁₀∈[0, ⅓], P₁ is a fluctuation rate at a 1-min time scale, and P₁₀ is a fluctuation rate at a 10-min time scale.

In S4, if the initial fluctuation rates at the two time scales do not meet the constraint condition, the modal decomposition order is updated; an order modal component and energy storage power are calculated by using a k^{th} modal decomposition calculation rule according to the modal decomposition order; and the energy storage power is inputted into the grid-connected power mathematical model to obtain updated fluctuation rates corresponding to the order modal component at the two time scales until the updated fluctuation rates meet the constraint condition, and energy storage power corresponding to the updated fluctuation rates meeting the constraint condition is taken as the stabilizing power of the integrated energy storage system of new energy power transmission.

It is to be noted that, in S4, the modal decomposition order k=k+1, then an order modal component and energy storage power that correspond to the modal decomposition order are calculated by using a k^{th} modal decomposition calculation rule according to the modal decomposition order, then the obtained energy storage power is inputted into the grid-connected power mathematical model to obtain updated fluctuation rates at the two time scales, the calculation is continuously iterated and updated until the updated fluctuation rates at the two time scales meet the constraint condition, and energy storage power corresponding to the updated fluctuation rates meeting the constraint condition is taken as the stabilizing power of the integrated energy storage system of new energy power transmission, so that grid-connected power in this case meets the grid-connected power required by the integrated energy storage system of new energy power transmission. In this embodiment, in steps S1 to S4 in the comprehensive control method for the power fluctuation-stabilizing energy storage system, grid-connected power meeting a grid connection requirement and the stabilizing power required to be stored by the integrated energy storage module are obtained in a manner of outer-layer control.

In S5, by using an energy storage integrated control mode, the integrated energy storage module is controlled to store the stabilizing power.

It is to be noted that, in the comprehensive control method for the power fluctuation-stabilizing energy storage system, by using the energy storage integrated control mode in the manner of inner-layer control, the integrated energy storage module is controlled to store the stabilizing power.

The present disclosure provides a comprehensive control method for a power fluctuation-stabilizing energy storage system. The method includes acquiring a topological structure diagram, a total power of generation, and an initial value of modal decomposition order of the integrated energy storage system of new energy power transmission, constructing a grid-connected power mathematical model according to the topological structure diagram, and adding I Gaussian white noises to the total power of generation to construct a power data set including I pieces of data; calculating a first-order modal component and initial energy storage power by using a first-order modal decomposition calculation rule according to the initial value of modal decomposition order, and inputting the initial energy storage power into the grid-connected power mathematical model to obtain initial fluctuation rates corresponding to the first-order modal component at two time scales; if the initial fluctuation rates at the two time scales meet a constraint condition, taking the initial energy storage power as stabilizing power of the integrated energy storage system of new energy power transmission; if the initial fluctuation rates at the two time scales do not meet the constraint condition, updating the modal decomposition order; calculating an order modal component and energy storage power by using a k^{th} modal decomposition calculation rule according to the modal decomposition order; and inputting the energy storage power into the grid-connected power mathematical model to obtain updated fluctuation rates corresponding to the order modal component at the two time scales until the updated fluctuation rates meet the constraint condition, and taking energy storage power corresponding to the updated fluctuation rates meeting the constraint condition as the stabilizing power of the integrated energy storage system of new energy power transmission; and controlling, by using an energy storage integrated control mode, the integrated energy storage module to store the stabilizing power. In the comprehensive control method for the power fluctuation-stabilizing energy storage system, stabilizing power is calculated by means of EMD, so that the energy storage rated power requirement and the operational burden of the integrated energy storage system of new energy power transmission can be reduced in the operation of grid-connected power corresponding to the stabilizing power. An energy storage integrated control mode is used to control the integrated energy storage module to operate at an optimal depth of discharge, so that the cycle life of the integrated energy storage module is fully utilized, and the service life of the integrated energy storage module is prolonged, thereby solving the technical problems of low system operational efficiency and short service life of energy storage elements thereof in power fluctuation stabilizing processes of existing new energy power transmission systems.

In an embodiment of the present disclosure, content of the energy storage integrated control mode includes:
acquiring parameter data of the integrated energy storage module, the parameter data including a rated charging power, a rated discharging power, a rated energy storage power, a rated energy storage capacity, a charging/discharging upper limit, a charging/discharging lower limit, operating efficiency parameters, and a power control cycle;
calculating a charging power, a discharging power, a remaining charging capacity of energy storage, and a remaining discharging capacity of energy storage of the integrated energy storage module according to the parameter data; and
controlling the first energy storage element, the second energy storage element, and the third energy storage element to store the stabilizing power by switching between thirteen operating conditions according to the charging/discharging upper limit, the charging/discharging lower limit, the charging power, and the discharging power.

The thirteen operating conditions include a first operating condition, a second operating condition, a third operating condition, a fourth operating condition, a fifth operating condition, a sixth operating condition, a seventh operating condition, an eighth operating condition, a ninth operating condition, a tenth operating condition, an eleventh operating condition, a twelfth operating condition, and a thirteenth operating condition.

It is to be noted that, a charging power, a discharging power, a remaining charging capacity of energy storage, and a remaining discharging capacity of energy storage of the integrated energy storage module are calculated by using a remaining energy storage capacity calculation formula according to the parameter data. The remaining energy storage capacity calculation formula is:

$${P}_{c h} ( t ) = min \{ {P}_{BESS , ch} ( t ) \cdot η , \frac{{P}_{BESS \_ rate}}{2} , \frac{\frac{{E}_{BESS \_ rate}}{2} \cdot [ {S}_{c , max} - {S}_{oc , ch} ( t - 1 ) ]}{η \cdot Δ t} \} ;$$

$${P}_{dis} ( t ) = max \{ \frac{{P}_{BESS , dis} ( t )}{η} , \frac{- {P}_{BESS , rate}}{2} , \frac{η \cdot \frac{{E}_{BESS \_ rate}}{2} \cdot [ {S}_{d , min} - {S}_{oc , dis} ( t - 1 ) ]}{Δ t} \} ;$$

$${S}_{oc , ch} ( t ) = {S}_{oc , ch} ( t - Δ t ) + {\int }_{t - Δ t}^{t} {P}_{c h} ( c ) \cdot dc ; and$$

$${S}_{oc , dis} ( t ) = {S}_{oc , dis} ( t - Δ t ) + {\int }_{t - Δ t}^{t} {P}_{dis} ( c ) \cdot dc$$

where P_{BESS,ch} denotes a rated charging power, P_{BESS,dis} denotes a rated discharging power, P_{BESS_rate} denotes a rated energy storage power, E_{BESS_rate} denotes a rated energy storage capacity, S_{c,max} denotes a charging/discharging upper limit, S_{d,min} denotes a charging/discharging lower limit, η denotes an operating efficiency parameter, Δt denotes a power control cycle, t denotes time, P_{ch} denotes charging power, P_{dis} denotes discharging power, S_{oc,ch} denotes a remaining charging capacity of energy storage, S_{oc,dis} denotes a remaining discharging capacity of energy storage, and c denotes an integral variable and does not represent any physical meaning. In this embodiment, S_{c,max} may be selected as 0.9, and S_{d,min} may be selected as 0.1. An initial SOC of each energy storage element in the integrated energy storage module may be selected as 0.5. Thirteen operating conditions of the integrated energy storage module are shown in Table 1 below. In a first operating condition, the first energy storage element is in a charging state, the second energy storage element is in a discharging state, and the third energy storage element is in a standby state. In a second operating condition, the first energy storage element is in a standby state at a charging/discharging upper limit, the second energy storage element is in the discharging state, and the third energy storage element is in the charging state. In a third operating condition, the first energy storage element is in the charging state, the second energy storage element is in a standby state at a charging/discharging lower limit, and the third energy storage element is in the discharging state. In a fourth operating condition, the first energy storage element is in the discharging state, the second energy storage element is in the standby state at the charging/discharging lower limit, and the third energy storage element is in the charging state. In a fifth operating condition, the first energy storage element is in the discharging state, the second energy storage element is in the charging state, and the third energy storage element is in the standby state at the charging/discharging upper limit. In a sixth operating condition, the first energy storage element is in the standby state at the charging/discharging upper limit, the second energy storage element is in the charging state, and the third energy storage element is in the discharging state. In a seventh operating condition, the first energy storage element is in the discharging state, the second energy storage element is in the charging state, and the third energy storage element is in the standby state at the charging/discharging lower limit. In an eighth operating condition, the first energy storage element is in the standby state at the charging/discharging lower limit, the second energy storage element is in the charging state, and the third energy storage element is in the discharging state. In a ninth operating condition, the first energy storage element is in the charging state, the second energy storage element is in the standby state at the charging/discharging upper limit, and the third energy storage element is in the discharging state. In a tenth operating condition, the first energy storage element is in the discharging state, the second energy storage element is in the standby state at the charging/discharging upper limit, and the third energy storage element is in the charging state. In an eleventh operating condition, the first energy storage element is in the standby state at the charging/discharging lower limit, the second energy storage element is in the discharging state, and the third energy storage element is in the charging state. In a twelfth operating condition, the first energy storage element is in the charging state, the second energy storage element is in the discharging state, and the third energy storage element is in the standby state at the charging/discharging lower limit. In a thirteenth operating condition, the first energy storage element is in the charging state, the second energy storage element is in the discharging state, and the third energy storage element is in the standby state at the charging/discharging upper limit.

TABLE 1
Thirteen operating conditions of the
integrated energy storage module

| | A energy | B energy | C energy |
|---|---|---|---|
| | storage state | storage state | storage state |
| First operating | Charge | Discharge | Standby (0.5) |
| condition | | | |
| Second operating | Standby (0.9) | Discharge | Charge |
| condition | | | |
| Third operating | Charge | Standby (0.1) | Discharge |
| condition | | | |
| Fourth operating | Discharge | Standby (0.1) | Charge |
| condition | | | |
| Fifth operating | Discharge | Charge | Standby (0.9) |
| condition | | | |
| Sixth operating | Standby (0.9) | Charge | Discharge |
| condition | | | |
| Seventh operating | Discharge | Charge | Standby (0.1) |
| condition | | | |
| Eighth operating | Standby (0.1) | Charge | Discharge |
| condition | | | |
| Ninth operating | Charge | Standby (0.9) | Discharge |
| condition | | | |
| Tenth operating | Discharge | Standby (0.9) | Charge |
| condition | | | |
| Eleventh operating | Standby (0.1) | Discharge | Charge |
| condition | | | |
| Twelfth operating | Charge | Discharge | Standby (0.1) |
| condition | | | |
| Thirteenth operating | Charge | Discharge | Standby (0.9) |
| condition | | | |

In the embodiments of the present disclosure, the energy storage integrated control mode is to control the integrated energy storage module to track the stabilizing power P_{BESS} to stabilize fluctuations of total transmit power. In the energy storage integrated control mode, the first energy storage element A stores energy and is charged to stabilize positive fluctuations in the total power of generation, the second energy storage element B stores energy and is discharged to stabilize negative fluctuations in the total power of generation, and the third energy storage element C serves as a backup. When the first energy storage element A or the second energy storage element B cannot fully track the stabilizing power due to a rated power or SOC constraint, the third energy storage element C stores energy to provide compensation. If the requirement still cannot be met, the second energy storage element B or the first energy storage element A stores energy to provide compensation.

It is to be noted that the energy storage integrated control mode can effectively stabilize power fluctuations through inter-group coordination, and significantly enhance robustness against charge-discharge energy imbalance in the energy storage integrated control mode, so that the energy storage elements store energy and can operate at the optimal depth of discharge, which can fully utilize the cycle life thereof and reduce loss of the battery life of the energy storage elements during operation, thereby improving lifespan utilization thereof.

In the embodiments of the present disclosure, the controlling the first energy storage element, the second energy storage element, and the third energy storage element to store the stabilizing power by switching between the thirteen operating conditions according to the charging/discharging upper limit, the charging/discharging lower limit, the charging power, and the discharging power includes:
when the integrated energy storage module is in the first operating condition, acquiring a first stored power amount of the first energy storage element charged at the charging power and a first remaining power amount of the second energy storage element discharged at the discharging power; if the first stored power amount reaches the charging/discharging upper limit, the integrated energy storage module switching to the second operating condition; and if the first remaining power amount reaches the charging/discharging lower limit, the integrated energy storage module switching to the third operating condition;
when the integrated energy storage module is in the second operating condition, acquiring a second stored power amount of the third energy storage element charged at the charging power and a second remaining power amount of the second energy storage element discharged at the discharging power; if the second stored power amount reaches the charging/discharging upper limit, the integrated energy storage module switching to the fifth operating condition; and if the second remaining power amount reaches the charging/discharging lower limit, the integrated energy storage module switching to the fourth operating condition;
when the integrated energy storage module is in the third operating condition, acquiring a third stored power amount of the first energy storage element charged at the charging power and a third remaining power amount of the third energy storage element discharged at the discharging power; if the third stored power amount reaches the charging/discharging upper limit, the integrated energy storage module switching to the sixth operating condition; and if the third remaining power amount reaches the charging/discharging lower limit, the integrated energy storage module switching to the seventh operating condition;
when the integrated energy storage module is in the fourth operating condition, acquiring a fourth stored power amount of the second energy storage element charged at the charging power and a fourth remaining power amount of the first energy storage element discharged at the discharging power; if the fourth stored power amount reaches the charging/discharging upper limit, the integrated energy storage module switching to the fifth operating condition; and if the fourth remaining power amount reaches the charging/discharging lower limit, the integrated energy storage module switching to the eighth operating condition;
when the integrated energy storage module is in the fifth operating condition, acquiring a fifth stored power amount of the second energy storage element charged at the charging power and a fifth remaining power amount of the first energy storage element discharged at the discharging power; if the fifth stored power amount reaches the charging/discharging upper limit, the integrated energy storage module switching to the ninth operating condition; and if the fifth remaining power amount reaches the charging/discharging lower limit, the integrated energy storage module switching to the eighth operating condition;
when the integrated energy storage module is in the sixth operating condition, acquiring a sixth stored power amount of the second energy storage element charged at the charging power and a sixth remaining power amount of the third energy storage element discharged at the discharging power; if the sixth stored power amount reaches the charging/discharging upper limit, the integrated energy storage module switching to the tenth operating condition; and if the sixth remaining power amount reaches the charging/discharging lower limit, the integrated energy storage module switching to the seventh operating condition;
when the integrated energy storage module is in the seventh operating condition, acquiring a seventh stored power amount of the second energy storage element charged at the charging power and a seventh remaining power amount of the first energy storage element discharged at the discharging power; if the seventh stored power amount reaches the charging/discharging upper limit, the integrated energy storage module switching to the tenth operating condition; and if the seventh remaining power amount reaches the charging/discharging lower limit, the integrated energy storage module switching to the eleventh operating condition;
when the integrated energy storage module is in the eighth operating condition, acquiring an eighth stored power amount of the second energy storage element charged at the charging power and an eighth remaining power amount of the third energy storage element discharged at the discharging power; if the eighth stored power amount reaches the charging/discharging upper limit, the integrated energy storage module switching to the ninth operating condition; and if the eighth remaining power amount reaches the charging/discharging lower limit, the integrated energy storage module switching to the twelfth operating condition;
when the integrated energy storage module is in the ninth operating condition, acquiring a ninth stored power amount of the first energy storage element charged at the charging power and a ninth remaining power amount of the third energy storage element discharged at the discharging power; if the ninth stored power amount reaches the charging/discharging upper limit, the integrated energy storage module switching to the second operating condition; and if the ninth remaining power amount reaches the charging/discharging lower limit, the integrated energy storage module switching to the twelfth operating condition;
when the integrated energy storage module is in the tenth operating condition, acquiring a tenth stored power amount of the third energy storage element charged at the charging power and a tenth remaining power amount of the first energy storage element discharged at the discharging power; if the tenth stored power amount reaches the charging/discharging upper limit, the integrated energy storage module switching to the thirteenth operating condition; and if the tenth remaining power amount reaches the charging/discharging lower limit, the integrated energy storage module switching to the eleventh operating condition;
when the integrated energy storage module is in the eleventh operating condition, acquiring an eleventh stored power amount of the second energy storage element charged at the charging power and an eleventh remaining power amount of the third energy storage element discharged at the discharging power; if the eleventh stored power amount reaches the charging/discharging upper limit, the integrated energy storage module switching to the third operating condition; and if the eleventh remaining power amount reaches the charging/discharging lower limit, the integrated energy storage module switching to the thirteenth operating condition;
when the integrated energy storage module is in the twelfth operating condition, acquiring a twelfth stored power amount of the first energy storage element charged at the charging power and a twelfth remaining power amount of the second energy storage element discharged at the discharging power; if the twelfth stored power amount reaches the charging/discharging upper limit, the integrated energy storage module switching to the second operating condition; and if the twelfth remaining power amount reaches the charging/discharging lower limit, the integrated energy storage module switching to the fourth operating condition; and
when the integrated energy storage module is in the thirteenth operating condition, acquiring a thirteenth stored power amount of the first energy storage element charged at the charging power and a thirteenth remaining power amount of the second energy storage element discharged at the discharging power; if the thirteenth stored power amount reaches the charging/discharging upper limit, the integrated energy storage module switching to the sixth operating condition; and if the thirteenth remaining power amount reaches the charging/discharging lower limit, the integrated energy storage module switching to the third operating condition.

It is to be noted that, in the energy storage integrated control mode, when the first energy storage element A stores energy and is charged to S_{oc,max}, the first energy storage element A is switched to the standby state, and the energy storage state of the third energy storage element C is switched to the charging state. When the second energy storage element B stores energy and is discharged to S_{oc,min}, the second energy storage element B is switched to the standby state, and the energy storage state of the third energy storage element C is switched to the discharging state.

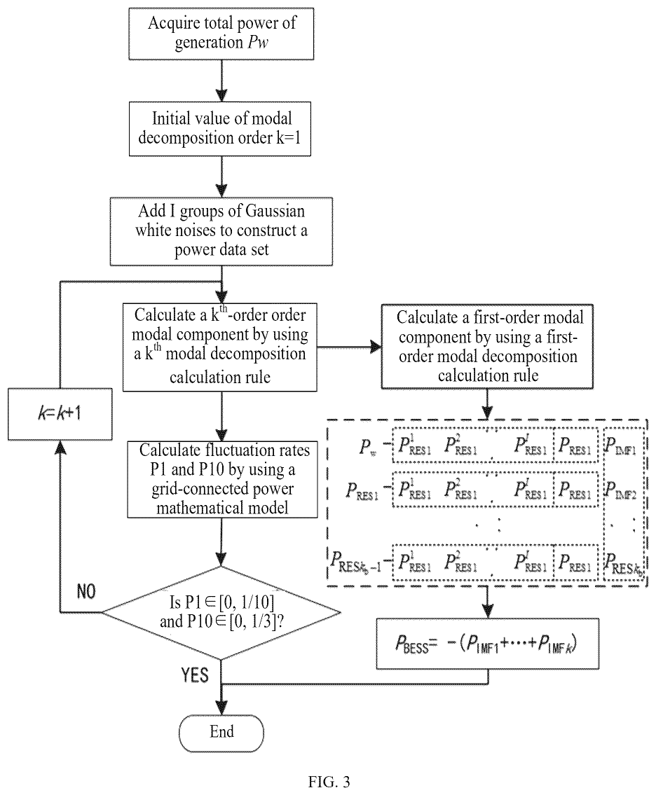

FIG. 3 is a flowchart of the comprehensive control method for the power fluctuation-stabilizing energy storage system according to embodiments of the present disclosure.

As shown in FIG. 3, in an embodiment of the present disclosure, content of the first-order modal decomposition calculation rule includes:
performing a calculation based on the power data set and the total power of generation by using a first residual operator formula, to obtain the first-order modal component; and
taking the first-order modal component as the initial energy storage power.

The first residual operator formula is:

$${P}_{IMF 1} = {P}_{w} - \frac{1}{I} {\sum }_{i = 1}^{I} M ( {P}_{w} + {w}_{i} ) , i = 1 , 2 , ⋯ , I$$

where P_{IMF1} denotes the first-order modal component, P_{w} denotes the total power of generation, wᵢ denotes the i^{th} Gaussian white noise, M(*) denotes a residual operator, and I denotes a total quantity of Gaussian white noises.

It is to be noted that, taking acquisition of a first-order modal component as an example, a decomposition process of the total power of generation based on ensemble EMD is shown in a first formula and a second formula. The first formula is:

$${P}_{IMF 1} = \frac{1}{I} {\sum }_{i = 1}^{I} {E}_{1} ( {P}_{w} + {w}_{i} ) .$$

The second formula is:

$$\begin{matrix}{P}_{IMF 1} = \frac{1}{I} {\sum }_{i = 1}^{I} [ {P}_{w} + {w}_{i} - M ( {P}_{w} + {w}_{i} ) ] \\ = \frac{1}{I} {\sum }_{i = 1}^{I} ( {P}_{w} + {w}_{i} ) - \frac{1}{I} {\sum }_{i = 1}^{I} M ( {P}_{w} + {w}_{i} )\end{matrix}$$

where Eₗ(*) denotes an order mode after EMD on *, and M(*) denotes an average value of maximum and minimum envelopes of * during the EMD, that is, the residual during the decomposition. In order to reduce an influence on the total power of generation during noise addition, in the comprehensive control method for the power fluctuation-stabilizing energy storage system, a modal component is obtained only by estimating a residual mean after addition of noise, as shown in a first residual operator formula.

As shown in FIG. 3, in an embodiment of the present disclosure, content of the k^{th} modal decomposition calculation rule includes:
performing EMD on the total power of generation according to the modal decomposition order, to obtain an order residual corresponding to the modal decomposition order;
adding the I Gaussian white noises to the order residual to construct a residual data set including I pieces of data;
performing a calculation based on the residual data set and a k−1^{th} order residual by using a second residual operator formula, to obtain the order modal component; and
performing a calculation based on all the order modal components by using an energy storage power calculation formula, to obtain energy storage power of first k orders.

The second residual operator formula is:

$${P}_{IMFk} = {P}_{RESk - 1} - \frac{1}{I} {\sum }_{i = 1}^{I} M ( {P}_{RESk} + {w}_{i} ) .$$

The energy storage power calculation formula is: P_{BESS}=P_{IMF1}+P_{IMF2}+ . . . +P_{IMFk}.

P_{IMFk} denotes a k^{th}-order order modal component, P_{RESk} denotes a k^{th}-order order residual, wᵢ denotes the i^{th} Gaussian white noise, M(*) denotes a residual operator, I denotes a total quantity of Gaussian white noises, and P_{BESS} denotes the energy storage power of the first k orders.

It is to be noted that a residual data set is

$${P}_{RESk}^{′} = {P}_{RESk} + {w}_{i} ,$$

where i=1, 2 . . . , and I, and wᵢ denotes an i^{th} Gaussian white noise. In this embodiment, the k^{th}-order order residual is obtained by decomposing data in the residual data set by using an EMD principle. The EMD principle is common knowledge in the art and will not be described in detail herein. According to the k^{th} modal decomposition calculation rule and the first-order modal decomposition calculation rule in the comprehensive control method for the power fluctuation-stabilizing energy storage system, high-frequency fluctuating power is gradually decomposed through a residual operator and reconstructed into energy storage power, and then a minimum number of times of residual decomposition is adaptively determined according to a grid connection requirement, which improves a situation of low efficiency caused by complete decomposition of a power signal in the conventional method, at the same time, can better analyze the local total power of generation and reduce aliased low-frequency power components in the energy storage power, and compared with methods such as low-pass filtering and moving average, effectively reduces additional energy storage power required due to the grid-connected power lagging behind the total power of generation, thereby reducing a power requirement and an operational burden of the integrated energy storage system of new energy power transmission.

In the embodiments of the present disclosure, the comprehensive control method for the power fluctuation-stabilizing energy storage system is applicable to large-scale wind power grid connection, and can effectively smooth fluctuations of the total power of generation during the grid connection and control an influence thereof on safe and stable operation of the power system within an acceptable range. Moreover, smoothed grid-connected power can better track the total power of generation, reducing a rated power requirement and operating energy loss of the integrated energy storage module. At the same time, each energy storage element of the integrated energy storage module can operate at the optimal depth of discharge, improving utilization of the cycle life thereof, thereby improving economic efficiency of the integrated energy storage module in a total power of generation fluctuation stabilizing scenario. In addition, the comprehensive control method for the power fluctuation-stabilizing energy storage system is also applicable to other power fluctuation scenarios that require frequent charge-discharge switching of energy storage, and has good promotion benefits.

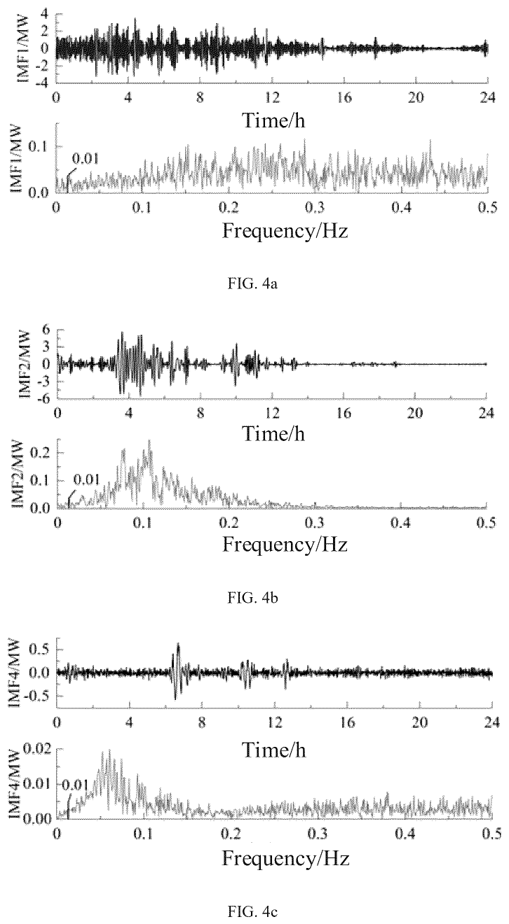

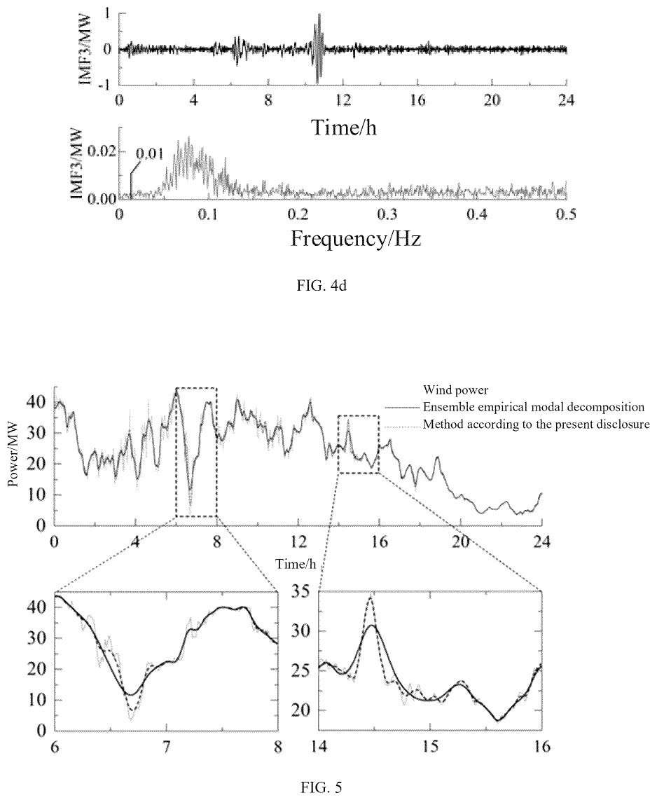

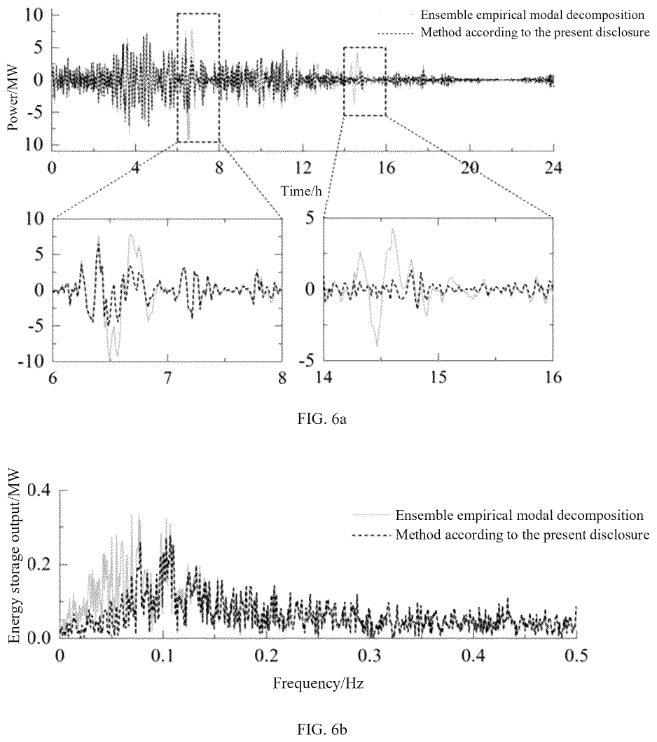

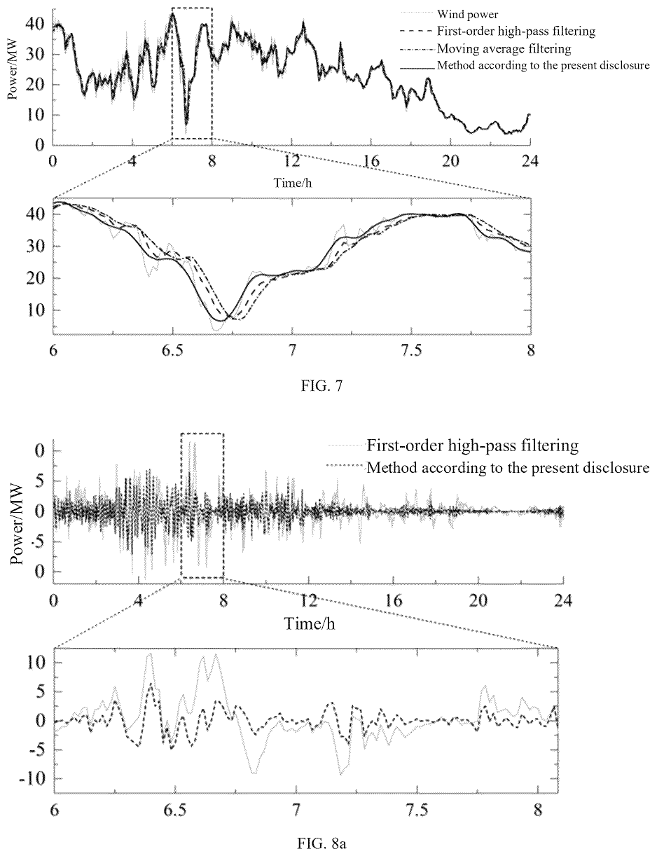

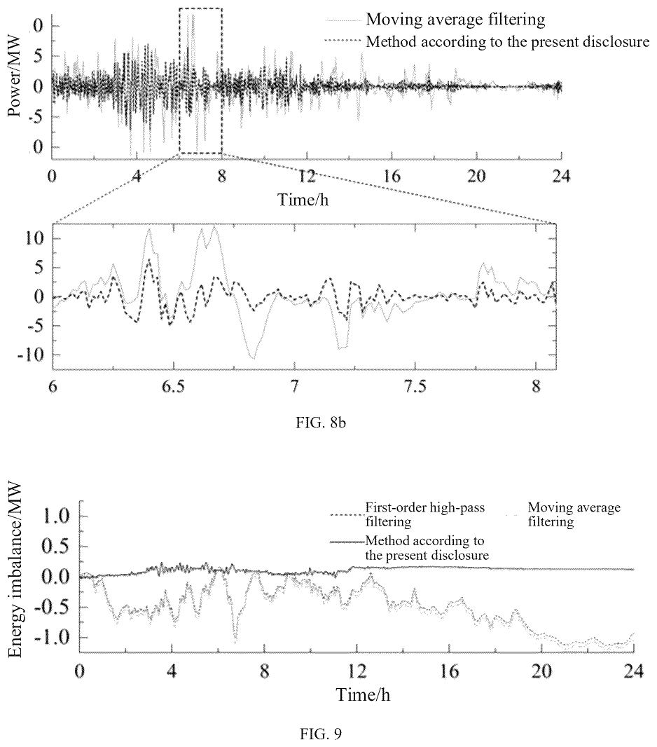

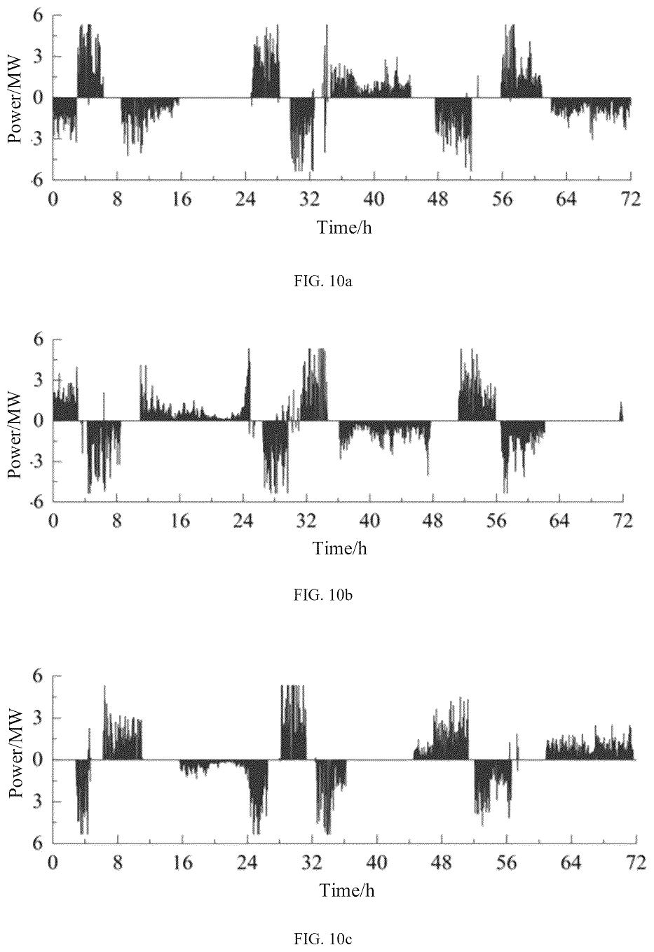

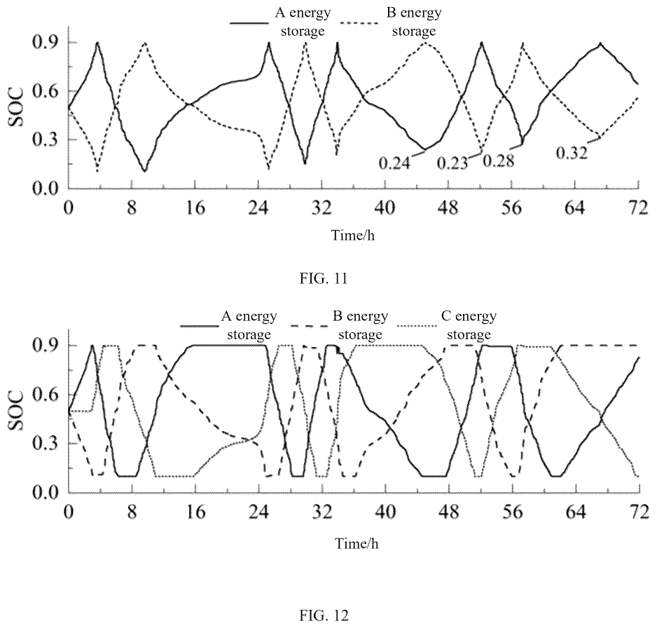

FIG. 4a is a diagram of a first-order mode during decomposition of the flowchart of the comprehensive control method for the power fluctuation-stabilizing energy storage system according to embodiments of the present disclosure, FIG. 4b is a diagram of a second-order mode during decomposition of the flowchart of the comprehensive control method for the power fluctuation-stabilizing energy storage system according to embodiments of the present disclosure, FIG. 4c is a diagram of a third-order mode during decomposition of the flowchart of the comprehensive control method for the power fluctuation-stabilizing energy storage system according to embodiments of the present disclosure, FIG. 4d is a diagram of a fourth-order mode during decomposition of the flowchart of the comprehensive control method for the power fluctuation-stabilizing energy storage system according to embodiments of the present disclosure, FIG. 5 is a graph of a total power of generation before and after smoothing by means of ensemble EMD and the comprehensive control method for the power fluctuation-stabilizing energy storage system according to embodiments of the present disclosure, FIG. 6a is a graph of energy storage power by means of ensemble EMD and the comprehensive control method for the power fluctuation-stabilizing energy storage system according to embodiments of the present disclosure, FIG. 6b is a frequency domain diagram of energy storage power by means of ensemble EMD and the comprehensive control method for the power fluctuation-stabilizing energy storage system according to embodiments of the present disclosure, FIG. 7 is a graph of a total power of generation before and after smoothing by using different control methods, FIG. 8a is a graph of energy storage power after first-order high-pass filtering, FIG. 8b is a graph of energy storage power under the comprehensive control method for the power fluctuation-stabilizing energy storage system according to embodiments of the present disclosure, FIG. 9 shows charge-discharge energy imbalance under different control methods, FIG. 10a is a power output diagram of a first energy storage element in the comprehensive control method for the power fluctuation-stabilizing energy storage system according to embodiments of the present disclosure, FIG. 10b is a power output diagram of a second energy storage element in the comprehensive control method for the power fluctuation-stabilizing energy storage system according to embodiments of the present disclosure, FIG. 10c is a power output diagram of a third energy storage element in the comprehensive control method for the power fluctuation-stabilizing energy storage system according to embodiments of the present disclosure, FIG. 11 is a diagram of SOC of individual parts in a conventional dual-battery integrated energy storage system, and FIG. 12 is a diagram of SOC of energy storage elements in the comprehensive control method for the power fluctuation-stabilizing energy storage system according to embodiments of the present disclosure.

In the embodiments of the present disclosure, effectiveness of the comprehensive control method for the power fluctuation-stabilizing energy storage system is verified using actual wind farm power data. As shown in FIG. 4a to FIG. 4d, after four decompositions, the grid-connected power obtained can meet the grid connection requirement. In this process, high-frequency fluctuating power components can be gradually analyzed, and aliased low-frequency power components (taking <0.01 Hz as an example) can be controlled within a very small range during each decomposition, so that the energy storage system can be accurately controlled to eliminate the high-frequency fluctuating power in the wind power with fewer decompositions. FIG. 5 shows wind power before and after smoothing by means of ensemble EMD and the comprehensive control method for the power fluctuation-stabilizing energy storage system. Compared with the EMD, the comprehensive control method for the power fluctuation-stabilizing energy storage system can better analyze local wind power, so that the local wind power can be better tracked under the premise of meeting a requirement of stabilizing, reducing the rated power requirement and the operational burden of the energy storage system. A maximum energy storage power requirement and operating energy loss are reduced from 9.26 MW and 4.39 MWh to 7.27 MW and 3.6 MWh. FIG. 6a and FIG. 6b show power and corresponding frequency domains of the integrated energy storage system of new energy power transmission during stabilizing. Compared with the EMD, by using the comprehensive control method for the power fluctuation-stabilizing energy storage system, the maximum energy storage power requirement is effectively controlled, and overall storage efficiency is improved due to better tracking of the wind power. At the same time, the use of the comprehensive control method for the power fluctuation-stabilizing energy storage system effectively improves a low-frequency power aliasing phenomenon in energy storage power, reduces ineffective energy exchange thereof, reduces energy loss of the integrated energy storage system of new energy power transmission, and improves stabilizing economy. Aliasing of low-frequency power components is reduced from 1.36% to 0.75%. FIG. 7, FIG. 8a, and FIG. 8b show grid-connected power and energy storage power before and after smoothing by using first-order low-pass filtering, moving average filtering, and the comprehensive control method for the power fluctuation-stabilizing energy storage system. When first-order low-pass filtering and moving average filtering are used, due to a phase lag during the control, the smoothed grid-connected power significantly lags behind the wind power, which also means that trend components induced by the phase lag are added to the energy storage power, thereby increasing the operational burden thereof. However, when the comprehensive control method for the power fluctuation-stabilizing energy storage system is used, the above problems are solved well, and both overall wind power smoothing and local wind power tracking can be taken into account. A rated power requirement of the integrated energy storage system of new energy power transmission is minimized, and the overall power output situation is improved. Compared with the first-order low-pass filtering and moving average filtering, when the comprehensive control method for the power fluctuation-stabilizing energy storage system is used, the maximum energy storage power requirement is reduced from 11.71 MW and 12.24 MW to 7.27 MW, and the operating energy loss is reduced from 6.51 MWh and 6.68 MWh to 3.6 MWh. FIG. 9 shows first-order low-pass filtering, moving average filtering, and energy imbalance of the present disclosure. Due to the phase lag in first-order low-pass filtering and moving average filtering, the energy imbalance is large during the control, while the comprehensive control method for the power fluctuation-stabilizing energy storage system significantly improves this situation, enabling the energy storage element to store energy and operate at a depth near the optimal depth of discharge. As shown in FIG. 10a and FIG. 10b, during the operation of each energy storage element of the integrated energy storage module, the energy storage of each energy storage element has different charging and discharging characteristics. When one energy storage element stores energy and is charged to stabilize positive wind power fluctuations, another energy storage element stores energy and is discharged to stabilize negative wind power fluctuations. The energy storage of the last energy storage element is in the standby state and compensation is provided when one energy storage element cannot stabilize the fluctuation due to a rated power or SOC constraint. As shown in FIG. 11 and FIG. 12, although the comprehensive control method for the power fluctuation-stabilizing energy storage system can better control charge-discharge energy imbalance, the dual-battery integrated system is very sensitive to energy imbalance, and energy storage in each battery cannot operate at the optimal depth of discharge in a cycle. However, the energy storage integrated control mode in the comprehensive control method for the power fluctuation-stabilizing energy storage system solves the problem, so that the energy storage in each battery can operate at the optimal depth of discharge in an operation cycle, making full use of the cycle life of the energy storage element.

### Embodiment II

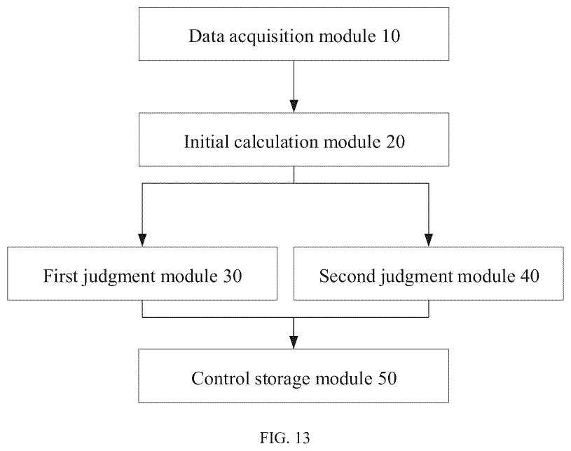

FIG. 13 is a flowchart of a framework of a comprehensive control apparatus for a power fluctuation-stabilizing energy storage system according to embodiments of the present disclosure.

As shown in FIG. 13, embodiments of the present disclosure provide a comprehensive control apparatus for a power fluctuation-stabilizing energy storage system is provided, applied to an integrated energy storage system of new energy power transmission, the integrated energy storage system of new energy power transmission includes an integrated energy storage module, and the comprehensive control apparatus includes a data acquisition module 10, an initial calculation module 20, a first judgment module 30, a second judgment module 40, and a control storage module 50.

The data acquisition module 10 is configured to acquire a topological structure diagram, a total power of generation, and an initial value of modal decomposition order of the integrated energy storage system of new energy power transmission, construct a grid-connected power mathematical model according to the topological structure diagram, and add I Gaussian white noises to the total power of generation to construct a power data set including I pieces of data.

The initial calculation module 20 is configured to calculate a first-order modal component and initial energy storage power by using a first-order modal decomposition calculation rule according to the initial value of modal decomposition order, and input the initial energy storage power into the grid-connected power mathematical model to obtain initial fluctuation rates corresponding to the first-order modal component at two time scales.

The first judgment module 30 is configured to, if the initial fluctuation rates at the two time scales meet a constraint condition, take the initial energy storage power as stabilizing power of the integrated energy storage system of new energy power transmission.

The second judgment module 40 is configured to, if the initial fluctuation rates at the two time scales do not meet the constraint condition, update the modal decomposition order; calculate an order modal component and energy storage power by using a k^{th} modal decomposition calculation rule according to the modal decomposition order; and input the energy storage power into the grid-connected power mathematical model to obtain updated fluctuation rates corresponding to the order modal component at the two time scales until the updated fluctuation rates meet the constraint condition, and take energy storage power corresponding to the updated fluctuation rates meeting the constraint condition as the stabilizing power of the integrated energy storage system of new energy power transmission.

The control storage module 50 is configured to control, by using an energy storage integrated control mode, the integrated energy storage module to store the stabilizing power.

In the embodiments of the present disclosure, the integrated energy storage module includes a first energy storage element, a second energy storage element, and a third energy storage element, and content of the energy storage integrated control mode includes:
acquiring parameter data of the integrated energy storage module, the parameter data including a rated charging power, a rated discharging power, a rated energy storage power, a rated energy storage capacity, a charging/discharging upper limit, a charging/discharging lower limit, operating efficiency parameters, and a power control cycle;
calculating a charging power, a discharging power, a remaining charging capacity of energy storage, and a remaining discharging capacity of energy storage of the integrated energy storage module according to the parameter data; and
controlling the first energy storage element, the second energy storage element, and the third energy storage element to store the stabilizing power by switching between thirteen operating conditions according to the charging/discharging upper limit, the charging/discharging lower limit, the charging power, and the discharging power;
the thirteen operating conditions including a first operating condition, a second operating condition, a third operating condition, a fourth operating condition, a fifth operating condition, a sixth operating condition, a seventh operating condition, an eighth operating condition, a ninth operating condition, a tenth operating condition, an eleventh operating condition, a twelfth operating condition, and a thirteenth operating condition;
when the integrated energy storage module is in the first operating condition, acquiring a first stored power amount of the first energy storage element charged at the charging power and a first remaining power amount of the second energy storage element discharged at the discharging power; if the first stored power amount reaches the charging/discharging upper limit, the integrated energy storage module switching to the second operating condition; and if the first remaining power amount reaches the charging/discharging lower limit, the integrated energy storage module switching to the third operating condition;
when the integrated energy storage module is in the second operating condition, acquiring a second stored power amount of the third energy storage element charged at the charging power and a second remaining power amount of the second energy storage element discharged at the discharging power; if the second stored power amount reaches the charging/discharging upper limit, the integrated energy storage module switching to the fifth operating condition; and if the second remaining power amount reaches the charging/discharging lower limit, the integrated energy storage module switching to the fourth operating condition;
when the integrated energy storage module is in the third operating condition, acquiring a third stored power amount of the first energy storage element charged at the charging power and a third remaining power amount of the third energy storage element discharged at the discharging power; if the third stored power amount reaches the charging/discharging upper limit, the integrated energy storage module switching to the sixth operating condition; and if the third remaining power amount reaches the charging/discharging lower limit, the integrated energy storage module switching to the seventh operating condition;
when the integrated energy storage module is in the fourth operating condition, acquiring a fourth stored power amount of the second energy storage element charged at the charging power and a fourth remaining power amount of the first energy storage element discharged at the discharging power; if the fourth stored power amount reaches the charging/discharging upper limit, the integrated energy storage module switching to the fifth operating condition; and if the fourth remaining power amount reaches the charging/discharging lower limit, the integrated energy storage module switching to the eighth operating condition;
when the integrated energy storage module is in the fifth operating condition, acquiring a fifth stored power amount of the second energy storage element charged at the charging power and a fifth remaining power amount of the first energy storage element discharged at the discharging power; if the fifth stored power amount reaches the charging/discharging upper limit, the integrated energy storage module switching to the ninth operating condition; and if the fifth remaining power amount reaches the charging/discharging lower limit, the integrated energy storage module switching to the eighth operating condition;
when the integrated energy storage module is in the sixth operating condition, acquiring a sixth stored power amount of the second energy storage element charged at the charging power and a sixth remaining power amount of the third energy storage element discharged at the discharging power; if the sixth stored power amount reaches the charging/discharging upper limit, the integrated energy storage module switching to the tenth operating condition; and if the sixth remaining power amount reaches the charging/discharging lower limit, the integrated energy storage module switching to the seventh operating condition;
when the integrated energy storage module is in the seventh operating condition, acquiring a seventh stored power amount of the second energy storage element charged at the charging power and a seventh remaining power amount of the first energy storage element discharged at the discharging power; if the seventh stored power amount reaches the charging/discharging upper limit, the integrated energy storage module switching to the tenth operating condition; and if the seventh remaining power amount reaches the charging/discharging lower limit, the integrated energy storage module switching to the eleventh operating condition;
when the integrated energy storage module is in the eighth operating condition, acquiring an eighth stored power amount of the second energy storage element charged at the charging power and an eighth remaining power amount of the third energy storage element discharged at the discharging power; if the eighth stored power amount reaches the charging/discharging upper limit, the integrated energy storage module switching to the ninth operating condition; and if the eighth remaining power amount reaches the charging/discharging lower limit, the integrated energy storage module switching to the twelfth operating condition;
when the integrated energy storage module is in the ninth operating condition, acquiring a ninth stored power amount of the first energy storage element charged at the charging power and a ninth remaining power amount of the third energy storage element discharged at the discharging power; if the ninth stored power amount reaches the charging/discharging upper limit, the integrated energy storage module switching to the second operating condition; and if the ninth remaining power amount reaches the charging/discharging lower limit, the integrated energy storage module switching to the twelfth operating condition;
when the integrated energy storage module is in the tenth operating condition, acquiring a tenth stored power amount of the third energy storage element charged at the charging power and a tenth remaining power amount of the first energy storage element discharged at the discharging power; if the tenth stored power amount reaches the charging/discharging upper limit, the integrated energy storage module switching to the thirteenth operating condition; and if the tenth remaining power amount reaches the charging/discharging lower limit, the integrated energy storage module switching to the eleventh operating condition;
when the integrated energy storage module is in the eleventh operating condition, acquiring an eleventh stored power amount of the second energy storage element charged at the charging power and an eleventh remaining power amount of the third energy storage element discharged at the discharging power; if the eleventh stored power amount reaches the charging/discharging upper limit, the integrated energy storage module switching to the third operating condition; and if the eleventh remaining power amount reaches the charging/discharging lower limit, the integrated energy storage module switching to the thirteenth operating condition;
when the integrated energy storage module is in the twelfth operating condition, acquiring a twelfth stored power amount of the first energy storage element charged at the charging power and a twelfth remaining power amount of the second energy storage element discharged at the discharging power; if the twelfth stored power amount reaches the charging/discharging upper limit, the integrated energy storage module switching to the second operating condition; and if the twelfth remaining power amount reaches the charging/discharging lower limit, the integrated energy storage module switching to the fourth operating condition; and
when the integrated energy storage module is in the thirteenth operating condition, acquiring a thirteenth stored power amount of the first energy storage element charged at the charging power and a thirteenth remaining power amount of the second energy storage element discharged at the discharging power; if the thirteenth stored power amount reaches the charging/discharging upper limit, the integrated energy storage module switching to the sixth operating condition; and if the thirteenth remaining power amount reaches the charging/discharging lower limit, the integrated energy storage module switching to the third operating condition.

It is to be noted that the modules in the apparatus in Embodiment II correspond to the steps in the method in Embodiment I. the content of the comprehensive control method for the power fluctuation-stabilizing energy storage system has been described in detail in Embodiment I, and content of the modules in the apparatus in Embodiment II is no longer described in detail herein.

### Embodiment III

This embodiment of the present disclosure provides a terminal device, including a processor and a memory.

The memory is configured to store program code and transmit the program code to the processor.

The processor is configured to perform, according to instructions in the program code, the comprehensive control method for the power fluctuation-stabilizing energy storage system above.

It is to be noted that the processor is configured to perform, according to instructions in the program code, steps in the comprehensive control method for the power fluctuation-stabilizing energy storage system above. Alternatively, when the processor executes the computer program, the functions of the modules/units in the foregoing system/apparatus embodiments are implemented.

For example, the computer program may be divided into one or more modules/units, and the one or more modules/units are stored in the memory and executed by the processor to complete the present disclosure. The one or more modules/units may be a series of computer program instruction segments capable of performing specific functions, and the instruction segments are used to describe an execution process of the computer program in the terminal device.

The terminal device can be a computing device such as a desktop computer, a notebook computer, a PDA, or a cloud server. The terminal device may include, but is not limited to, a processor and a memory. Those skilled in the art may understand that this does not constitute a limitation on the terminal device, and may include more or fewer components than those shown in the figure, or a combination of certain components, or different components. For example, the terminal device may also include an input/output device, a network access device, a bus, and the like.

The processor may be a central processing unit (CPU), or another general-purpose processor, a digital signal processor (DSP), an application-specific integrated circuit (ASIC), a field-programmable gate array (FPGA) or another programmable logic device, a discrete gate or transistor logic device, a discrete hardware component, or the like. The general-purpose processor may be a microprocessor, or the processor may be any conventional processor or the like.

The memory may be an internal storage unit of the terminal device, such as a hard disk or an internal memory of the terminal device. The memory may alternatively be an external storage device of the terminal device, for example, a plug-in hard disk, a smart media card (SMC), a secure digital (SD) card, or a flash card that is equipped on the terminal device. Further, the memory may include both an internal storage unit and an external storage device of the terminal device. The memory is configured to store computer programs and other programs and data required by the terminal device. The memory may also be configured to temporarily store data that has been outputted or is about to be outputted.

Those skilled in the art can clearly understand that, for the convenience and brevity of the description, for a detailed operating process of the foregoing system, apparatus, and unit, reference may be made to a corresponding process in the foregoing method embodiments, and details are not described herein again.

In the several embodiments provided in the present disclosure, it should be understood that the disclosed systems, apparatuses, and methods may be implemented in other manners. For example, the described apparatus embodiments are merely examples. For example, the unit division is merely logical function division and may be another division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located at one position, or may be distributed on a plurality of network units. Some or all of the units may be selected according to an actual requirement to achieve the objectives of the solutions of the embodiments.

In addition, functional units in the embodiments of the present disclosure may be integrated into one processing unit, or each of the units may exist alone physically, or two or more units are integrated into one unit. The above integrated unit may be implemented in the form of hardware or in the form of a software functional unit.

When implemented in the form of a software functional unit and sold or used as an independent product, the integrated units may be stored in a computer-readable storage medium. Based on such an understanding, the technical solutions of the present disclosure essentially, or the part contributing to the prior art, or all or some of the technical solutions may be implemented in the form of a software product. The computer software product is stored in a storage medium, and includes several instructions for instructing a computer device (which may be a personal computer, a server, a network device, or the like) to perform all or some of the steps of the methods described in the embodiments of the present disclosure. The foregoing storage medium includes: any medium that can store program code, such as a USB flash drive, a removable hard disk, a read-only memory (ROM), a random access memory (RAM), a magnetic disk, or an optical disc.

Based on the above, the above embodiments are merely intended to describe the technical solutions of the present disclosure, but not to limit the present disclosure. Although the present disclosure is described in detail with reference to the foregoing embodiments, those of ordinary skill in the art should understand that they may still make modifications to the technical solutions described in the foregoing embodiments or make equivalent replacements to some technical features thereof. Such modifications or replacements do not cause the essence of the corresponding technical solutions to depart from the spirit and scope of the technical solutions of the embodiments of the present disclosure.

1. A comprehensive control method for a power fluctuation-stabilizing energy storage system, applied to an integrated energy storage system of new energy power transmission, the integrated energy storage system of new energy power transmission comprising an integrated energy storage module, wherein the comprehensive control method comprises following steps:
acquiring a topological structure diagram, a total power of generation, and an initial value of modal decomposition order of the integrated energy storage system of new energy power transmission, constructing a grid-connected power mathematical model according to the topological structure diagram, and adding I Gaussian white noises to the total power of generation to construct a power data set comprising I pieces of data;
calculating a first-order modal component and initial energy storage power by using a first-order modal decomposition calculation rule according to the initial value of modal decomposition order, and inputting the initial energy storage power into the grid-connected power mathematical model to obtain initial fluctuation rates corresponding to the first-order modal component at two time scales;
if the initial fluctuation rates at the two time scales meet a constraint condition, taking the initial energy storage power as stabilizing power of the integrated energy storage system of new energy power transmission;
if the initial fluctuation rates at the two time scales do not meet the constraint condition, updating the modal decomposition order; calculating an order modal component and energy storage power by using a k^{th} modal decomposition calculation rule according to the modal decomposition order; and inputting the energy storage power into the grid-connected power mathematical model to obtain updated fluctuation rates corresponding to the order modal component at the two time scales until the updated fluctuation rates meet the constraint condition, and taking energy storage power corresponding to the updated fluctuation rates meeting the constraint condition as the stabilizing power of the integrated energy storage system of new energy power transmission; and
controlling, by using an energy storage integrated control mode, the integrated energy storage module to store the stabilizing power.

2. The comprehensive control method for the power fluctuation-stabilizing energy storage system according to claim 1, wherein the integrated energy storage module comprises a first energy storage element, a second energy storage element, and a third energy storage element, and content of the energy storage integrated control mode comprises:
acquiring parameter data of the integrated energy storage module, the parameter data comprising a rated charging power, a rated discharging power, a rated energy storage power, a rated energy storage capacity, a charging/discharging upper limit, a charging/discharging lower limit, operating efficiency parameters, and a power control cycle;
calculating a charging power, a discharging power, a remaining charging capacity of energy storage, and a remaining discharging capacity of energy storage of the integrated energy storage module according to the parameter data; and
controlling the first energy storage element, the second energy storage element, and the third energy storage element to store the stabilizing power by switching between thirteen operating conditions according to the charging/discharging upper limit, the charging/discharging lower limit, the charging power, and the discharging power;
the thirteen operating conditions comprising a first operating condition, a second operating condition, a third operating condition, a fourth operating condition, a fifth operating condition, a sixth operating condition, a seventh operating condition, an eighth operating condition, a ninth operating condition, a tenth operating condition, an eleventh operating condition, a twelfth operating condition, and a thirteenth operating condition.

3. The comprehensive control method for the power fluctuation-stabilizing energy storage system according to claim 2, wherein controlling the first energy storage element, the second energy storage element, and the third energy storage element to store the stabilizing power by switching between the thirteen operating conditions according to the charging/discharging upper limit, the charging/discharging lower limit, the charging power, and the discharging power comprises:
when the integrated energy storage module is in the first operating condition, acquiring a first stored power amount of the first energy storage element charged at the charging power and a first remaining power amount of the second energy storage element discharged at the discharging power; if the first stored power amount reaches the charging/discharging upper limit, the integrated energy storage module switching to the second operating condition; and if the first remaining power amount reaches the charging/discharging lower limit, the integrated energy storage module switching to the third operating condition;
when the integrated energy storage module is in the second operating condition, acquiring a second stored power amount of the third energy storage element charged at the charging power and a second remaining power amount of the second energy storage element discharged at the discharging power; if the second stored power amount reaches the charging/discharging upper limit, the integrated energy storage module switching to the fifth operating condition; and if the second remaining power amount reaches the charging/discharging lower limit, the integrated energy storage module switching to the fourth operating condition;
when the integrated energy storage module is in the third operating condition, acquiring a third stored power amount of the first energy storage element charged at the charging power and a third remaining power amount of the third energy storage element discharged at the discharging power; if the third stored power amount reaches the charging/discharging upper limit, the integrated energy storage module switching to the sixth operating condition; and if the third remaining power amount reaches the charging/discharging lower limit, the integrated energy storage module switching to the seventh operating condition;
when the integrated energy storage module is in the fourth operating condition, acquiring a fourth stored power amount of the third energy storage element charged at the charging power and a fourth remaining power amount of the first energy storage element discharged at the discharging power; if the fourth stored power amount reaches the charging/discharging upper limit, the integrated energy storage module switching to the fifth operating condition; and if the fourth remaining power amount reaches the charging/discharging lower limit, the integrated energy storage module switching to the eighth operating condition;
when the integrated energy storage module is in the fifth operating condition, acquiring a fifth stored power amount of the second energy storage element charged at the charging power and a fifth remaining power amount of the first energy storage element discharged at the discharging power; if the fifth stored power amount reaches the charging/discharging upper limit, the integrated energy storage module switching to the ninth operating condition; and if the fifth remaining power amount reaches the charging/discharging lower limit, the integrated energy storage module switching to the eighth operating condition;
when the integrated energy storage module is in the sixth operating condition, acquiring a sixth stored power amount of the second energy storage element charged at the charging power and a sixth remaining power amount of the third energy storage element discharged at the discharging power; if the sixth stored power amount reaches the charging/discharging upper limit, the integrated energy storage module switching to the tenth operating condition; and if the sixth remaining power amount reaches the charging/discharging lower limit, the integrated energy storage module switching to the seventh operating condition;
when the integrated energy storage module is in the seventh operating condition, acquiring a seventh stored power amount of the second energy storage element charged at the charging power and a seventh remaining power amount of the first energy storage element discharged at the discharging power; if the seventh stored power amount reaches the charging/discharging upper limit, the integrated energy storage module switching to the tenth operating condition; and if the seventh remaining power amount reaches the charging/discharging lower limit, the integrated energy storage module switching to the eleventh operating condition;
when the integrated energy storage module is in the eighth operating condition, acquiring an eighth stored power amount of the second energy storage element charged at the charging power and an eighth remaining power amount of the third energy storage element discharged at the discharging power; if the eighth stored power amount reaches the charging/discharging upper limit, the integrated energy storage module switching to the ninth operating condition; and if the eighth remaining power amount reaches the charging/discharging lower limit, the integrated energy storage module switching to the twelfth operating condition;
when the integrated energy storage module is in the ninth operating condition, acquiring a ninth stored power amount of the first energy storage element charged at the charging power and a ninth remaining power amount of the third energy storage element discharged at the discharging power; if the ninth stored power amount reaches the charging/discharging upper limit, the integrated energy storage module switching to the second operating condition; and if the ninth remaining power amount reaches the charging/discharging lower limit, the integrated energy storage module switching to the twelfth operating condition;
when the integrated energy storage module is in the tenth operating condition, acquiring a tenth stored power amount of the third energy storage element charged at the charging power and a tenth remaining power amount of the first energy storage element discharged at the discharging power; if the tenth stored power amount reaches the charging/discharging upper limit, the integrated energy storage module switching to the thirteenth operating condition; and if the tenth remaining power amount reaches the charging/discharging lower limit, the integrated energy storage module switching to the eleventh operating condition;
when the integrated energy storage module is in the eleventh operating condition, acquiring an eleventh remaining power amount of the second energy storage element discharged at the discharging power and an eleventh stored power amount of the third energy storage element charged at the charging power; if the eleventh remaining power amount reaches the charging/discharging lower limit, the integrated energy storage module switching to the third operating condition; and if the eleventh stored power amount reaches the charging/discharging upper limit, the integrated energy storage module switching to the thirteenth operating condition;
when the integrated energy storage module is in the twelfth operating condition, acquiring a twelfth stored power amount of the first energy storage element charged at the charging power and a twelfth remaining power amount of the second energy storage element discharged at the discharging power; if the twelfth stored power amount reaches the charging/discharging upper limit, the integrated energy storage module switching to the second operating condition; and if the twelfth remaining power amount reaches the charging/discharging lower limit, the integrated energy storage module switching to the fourth operating condition; and
when the integrated energy storage module is in the thirteenth operating condition, acquiring a thirteenth stored power amount of the first energy storage element charged at the charging power and a thirteenth remaining power amount of the second energy storage element discharged at the discharging power; if the thirteenth stored power amount reaches the charging/discharging upper limit, the integrated energy storage module switching to the sixth operating condition; and if the thirteenth remaining power amount reaches the charging/discharging lower limit, the integrated energy storage module switching to the third operating condition.

4. The comprehensive control method for the power fluctuation-stabilizing energy storage system according to claim 1, wherein content of the first-order modal decomposition calculation rule comprises:
performing a calculation based on the power data set and the total power of generation by using a first residual operator formula, to obtain the first-order modal component; and
taking the first-order modal component as the initial energy storage power;
the first residual operator formula being:
$${P}_{IMF 1} = {P}_{w} - \frac{1}{I} {\sum }_{i = 1}^{I} M ( {P}_{w} + {w}_{i} ) , i = 1 , 2 , ⋯ , I$$
where P_{IMF1} denotes the first-order modal component, P_{w} denotes the total power of generation, wᵢ denotes the i^{th} Gaussian white noise, M(*) denotes a residual operator, and I denotes a total quantity of Gaussian white noises.

5. The comprehensive control method for the power fluctuation-stabilizing energy storage system according to claim 1, wherein content of the k^{th} modal decomposition calculation rule comprises:
performing empirical modal decomposition on the total power of generation according to the modal decomposition order, to obtain an order residual corresponding to the modal decomposition order;
adding the I Gaussian white noises to the order residual to construct a residual data set comprising I pieces of data;
performing a calculation based on the residual data set and a k−1^{th} order residual by using a second residual operator formula, to obtain the order modal component; and
performing a calculation based on all the order modal components by using an energy storage power calculation formula, to obtain energy storage power of first k orders;
the second residual operator formula being:
$${P}_{IMFk} = {P}_{RESk - 1} - \frac{1}{I} {\sum }_{i = 1}^{I} M ( {P}_{RESk} + {w}_{i} ) ;$$
and
the energy storage power calculation formula being:
$${P}_{BESS} = {P}_{IMF 1} + {P}_{IMF 2} + ⋯ + {P}_{IMFk}$$
where P_{IMFk} denotes a k^{th}-order order modal component, P_{RESk} denotes a k^{th}-order order residual, wᵢ denotes the i^{th} Gaussian white noise, M(*) denotes a residual operator, I denotes a total quantity of Gaussian white noises, and P_{BESS} denotes the energy storage power of the first k orders.

6. The comprehensive control method for the power fluctuation-stabilizing energy storage system according to claim 1, wherein the grid-connected power mathematical model comprises a power expression and a fluctuation rate expression, the power expression being:
$${P}_{g} ( t ) = {\sum }_{l = 1}^{n} {P}_{wl} ( t ) + {P}_{BESS} ( t ) ;$$
and
the fluctuation rate expression being:
$${P}_{1} ( t ) = [ max {P}_{g} ( a ) - min {P}_{g} ( b ) ] / {P}_{w , rate}$$
$$a , b = t - 60 / {k}_{t} , t - ( 60 - {k}_{t} ) / {k}_{t} , … , t ;$$
$$and$$
$${P}_{10} ( t ) = [ max {P}_{g} ( a ) - min {P}_{g} ( b ) ] / {P}_{w , rate}$$
$$a , b = t - 600 / {k}_{t} , t - ( 600 - {k}_{t} ) / {k}_{t} , … , t$$
where P_{g}(t) denotes grid-connected power at time t, P_{wl}(t) denotes power outputted by an l^{th} generator unit at time t, P_{BESS}(t) denotes energy storage power at time t, n denotes a total number of generator units in the integrated energy storage system of new energy power transmission, P₁(t) denotes a fluctuation rate at a 1-min time scale at time t, P₁₀(t) denotes a fluctuation rate at a 10-min time scale at time t, P_{w, rate} denotes an installed capacity of a power plant in the integrated energy storage system of new energy power transmission, kₜ denotes a sampling interval, and a and b both denote sampling time.

7. The comprehensive control method for the power fluctuation-stabilizing energy storage system according to claim 1, wherein the constraint condition is P₁∈[0, 1/10] and P₁₀∈[0, ⅓], P₁ being a fluctuation rate at a 1-min time scale, and P₁₀ being a fluctuation rate at a 10-min time scale.

8. A comprehensive control apparatus for a power fluctuation-stabilizing energy storage system, applied to an integrated energy storage system of new energy power transmission, the integrated energy storage system of new energy power transmission comprising an integrated energy storage module, wherein the comprehensive control apparatus comprises a data acquisition module, an initial calculation module, a first judgment module, a second judgment module, and a control storage module;
the data acquisition module being configured to acquire a topological structure diagram, a total power of generation, and an initial value of modal decomposition order of the integrated energy storage system of new energy power transmission, construct a grid-connected power mathematical model according to the topological structure diagram, and add I Gaussian white noises to the total power of generation to construct a power data set comprising I pieces of data;
the initial calculation module being configured to calculate a first-order modal component and initial energy storage power by using a first-order modal decomposition calculation rule according to the initial value of modal decomposition order, and input the initial energy storage power into the grid-connected power mathematical model to obtain initial fluctuation rates corresponding to the first-order modal component at two time scales;
the first judgment module being configured to, if the initial fluctuation rates at the two time scales meet a constraint condition, take the initial energy storage power as stabilizing power of the integrated energy storage system of new energy power transmission;
the second judgment module being configured to, if the initial fluctuation rates at the two time scales do not meet the constraint condition, update the modal decomposition order; calculate an order modal component and energy storage power by using a k^{th} modal decomposition calculation rule according to the modal decomposition order; and input the energy storage power into the grid-connected power mathematical model to obtain updated fluctuation rates corresponding to the order modal component at the two time scales until the updated fluctuation rates meet the constraint condition, and take energy storage power corresponding to the updated fluctuation rates meeting the constraint condition as the stabilizing power of the integrated energy storage system of new energy power transmission; and
the control storage module being configured to control, by using an energy storage integrated control mode, the integrated energy storage module to store the stabilizing power.

9. The comprehensive control apparatus for a power fluctuation-stabilizing energy storage system according to claim 8, wherein the integrated energy storage module comprises a first energy storage element, a second energy storage element, and a third energy storage element, and content of the energy storage integrated control mode comprises:
acquiring parameter data of the integrated energy storage module, the parameter data comprising a rated charging power, a rated discharging power, a rated energy storage power, a rated energy storage capacity, a charging/discharging upper limit, a charging/discharging lower limit, operating efficiency parameters, and a power control cycle;
calculating a charging power, a discharging power, a remaining charging capacity of energy storage, and a remaining discharging capacity of energy storage of the integrated energy storage module according to the parameter data; and
controlling the first energy storage element, the second energy storage element, and the third energy storage element to store the stabilizing power by switching between thirteen operating conditions according to the charging/discharging upper limit, the charging/discharging lower limit, the charging power, and the discharging power;
the thirteen operating conditions comprising a first operating condition, a second operating condition, a third operating condition, a fourth operating condition, a fifth operating condition, a sixth operating condition, a seventh operating condition, an eighth operating condition, a ninth operating condition, a tenth operating condition, an eleventh operating condition, a twelfth operating condition, and a thirteenth operating condition;
when the integrated energy storage module is in the first operating condition, acquiring a first stored power amount of the first energy storage element charged at the charging power and a first remaining power amount of the second energy storage element discharged at the discharging power; if the first stored power amount reaches the charging/discharging upper limit, the integrated energy storage module switching to the second operating condition; and if the first remaining power amount reaches the charging/discharging lower limit, the integrated energy storage module switching to the third operating condition;
when the integrated energy storage module is in the second operating condition, acquiring a second stored power amount of the third energy storage element charged at the charging power and a second remaining power amount of the second energy storage element discharged at the discharging power; if the second stored power amount reaches the charging/discharging upper limit, the integrated energy storage module switching to the fifth operating condition; and if the second remaining power amount reaches the charging/discharging lower limit, the integrated energy storage module switching to the fourth operating condition;
when the integrated energy storage module is in the third operating condition, acquiring a third stored power amount of the first energy storage element charged at the charging power and a third remaining power amount of the third energy storage element discharged at the discharging power; if the third stored power amount reaches the charging/discharging upper limit, the integrated energy storage module switching to the sixth operating condition; and if the third remaining power amount reaches the charging/discharging lower limit, the integrated energy storage module switching to the seventh operating condition;
when the integrated energy storage module is in the fourth operating condition, acquiring a fourth stored power amount of the third energy storage element charged at the charging power and a fourth remaining power amount of the first energy storage element discharged at the discharging power; if the fourth stored power amount reaches the charging/discharging upper limit, the integrated energy storage module switching to the fifth operating condition; and if the fourth remaining power amount reaches the charging/discharging lower limit, the integrated energy storage module switching to the eighth operating condition;
when the integrated energy storage module is in the fifth operating condition, acquiring a fifth stored power amount of the second energy storage element charged at the charging power and a fifth remaining power amount of the first energy storage element discharged at the discharging power; if the fifth stored power amount reaches the charging/discharging upper limit, the integrated energy storage module switching to the ninth operating condition; and if the fifth remaining power amount reaches the charging/discharging lower limit, the integrated energy storage module switching to the eighth operating condition;
when the integrated energy storage module is in the sixth operating condition, acquiring a sixth stored power amount of the second energy storage element charged at the charging power and a sixth remaining power amount of the third energy storage element discharged at the discharging power; if the sixth stored power amount reaches the charging/discharging upper limit, the integrated energy storage module switching to the tenth operating condition; and if the sixth remaining power amount reaches the charging/discharging lower limit, the integrated energy storage module switching to the seventh operating condition;
when the integrated energy storage module is in the seventh operating condition, acquiring a seventh stored power amount of the second energy storage element charged at the charging power and a seventh remaining power amount of the first energy storage element discharged at the discharging power; if the seventh stored power amount reaches the charging/discharging upper limit, the integrated energy storage module switching to the tenth operating condition; and if the seventh remaining power amount reaches the charging/discharging lower limit, the integrated energy storage module switching to the eleventh operating condition;
when the integrated energy storage module is in the eighth operating condition, acquiring an eighth stored power amount of the second energy storage element charged at the charging power and an eighth remaining power amount of the third energy storage element discharged at the discharging power; if the eighth stored power amount reaches the charging/discharging upper limit, the integrated energy storage module switching to the ninth operating condition; and if the eighth remaining power amount reaches the charging/discharging lower limit, the integrated energy storage module switching to the twelfth operating condition;
when the integrated energy storage module is in the ninth operating condition, acquiring a ninth stored power amount of the first energy storage element charged at the charging power and a ninth remaining power amount of the third energy storage element discharged at the discharging power; if the ninth stored power amount reaches the charging/discharging upper limit, the integrated energy storage module switching to the second operating condition; and if the ninth remaining power amount reaches the charging/discharging lower limit, the integrated energy storage module switching to the twelfth operating condition;
when the integrated energy storage module is in the tenth operating condition, acquiring a tenth stored power amount of the third energy storage element charged at the charging power and a tenth remaining power amount of the first energy storage element discharged at the discharging power; if the tenth stored power amount reaches the charging/discharging upper limit, the integrated energy storage module switching to the thirteenth operating condition; and if the tenth remaining power amount reaches the charging/discharging lower limit, the integrated energy storage module switching to the eleventh operating condition;
when the integrated energy storage module is in the eleventh operating condition, acquiring an eleventh remaining power amount of the second energy storage element discharged at the discharging power and an eleventh stored power amount of the third energy storage element charged at the discharging power; if the eleventh remaining power amount reaches the charging/discharging lower limit, the integrated energy storage module switching to the third operating condition; and if the eleventh stored power amount reaches the charging/discharging upper limit, the integrated energy storage module switching to the thirteenth operating condition;
when the integrated energy storage module is in the twelfth operating condition, acquiring a twelfth stored power amount of the first energy storage element charged at the charging power and a twelfth remaining power amount of the second energy storage element discharged at the discharging power; if the twelfth stored power amount reaches the charging/discharging upper limit, the integrated energy storage module switching to the second operating condition; and if the twelfth remaining power amount reaches the charging/discharging lower limit, the integrated energy storage module switching to the fourth operating condition; and
when the integrated energy storage module is in the thirteenth operating condition, acquiring a thirteenth stored power amount of the first energy storage element charged at the charging power and a thirteenth remaining power amount of the second energy storage element discharged at the discharging power; if the thirteenth stored power amount reaches the charging/discharging upper limit, the integrated energy storage module switching to the sixth operating condition; and if the thirteenth remaining power amount reaches the charging/discharging lower limit, the integrated energy storage module switching to the third operating condition.

10. A terminal device, comprising a processor and a memory;
the memory being configured to store program code and transmit the program code to the processor; and
the processor being configured to perform, according to instructions in the program code, a comprehensive control method for a power fluctuation-stabilizing energy storage system,
wherein comprehensive control method is applied to an integrated energy storage system of new energy power transmission, and the integrated energy storage system of new energy power transmission comprising an integrated energy storage module, and
wherein the comprehensive control method comprises:
acquiring a topological structure diagram, a total power of generation, and an initial value of modal decomposition order of the integrated energy storage system of new energy power transmission, constructing a grid-connected power mathematical model according to the topological structure diagram, and adding I Gaussian white noises to the total power of generation to construct a power data set comprising I pieces of data;
calculating a first-order modal component and initial energy storage power by using a first-order modal decomposition calculation rule according to the initial value of modal decomposition order, and inputting the initial energy storage power into the grid-connected power mathematical model to obtain initial fluctuation rates corresponding to the first-order modal component at two time scales;
if the initial fluctuation rates at the two time scales meet a constraint condition, taking the initial energy storage power as stabilizing power of the integrated energy storage system of new energy power transmission;
if the initial fluctuation rates at the two time scales do not meet the constraint condition, updating the modal decomposition order; calculating an order modal component and energy storage power by using a k^{th} modal decomposition calculation rule according to the modal decomposition order; and inputting the energy storage power into the grid-connected power mathematical model to obtain updated fluctuation rates corresponding to the order modal component at the two time scales until the updated fluctuation rates meet the constraint condition, and taking energy storage power corresponding to the updated fluctuation rates meeting the constraint condition as the stabilizing power of the integrated energy storage system of new energy power transmission; and
controlling, by using an energy storage integrated control mode, the integrated energy storage module to store the stabilizing power.

11. The terminal device according to claim 10, wherein the integrated energy storage module comprises a first energy storage element, a second energy storage element, and a third energy storage element, and content of the energy storage integrated control mode comprises:
acquiring parameter data of the integrated energy storage module, the parameter data comprising a rated charging power, a rated discharging power, a rated energy storage power, a rated energy storage capacity, a charging/discharging upper limit, a charging/discharging lower limit, operating efficiency parameters, and a power control cycle;
calculating a charging power, a discharging power, a remaining charging capacity of energy storage, and a remaining discharging capacity of energy storage of the integrated energy storage module according to the parameter data; and
controlling the first energy storage element, the second energy storage element, and the third energy storage element to store the stabilizing power by switching between thirteen operating conditions according to the charging/discharging upper limit, the charging/discharging lower limit, the charging power, and the discharging power;
the thirteen operating conditions comprising a first operating condition, a second operating condition, a third operating condition, a fourth operating condition, a fifth operating condition, a sixth operating condition, a seventh operating condition, an eighth operating condition, a ninth operating condition, a tenth operating condition, an eleventh operating condition, a twelfth operating condition, and a thirteenth operating condition.

12. The terminal device according to claim 11, wherein controlling the first energy storage element, the second energy storage element, and the third energy storage element to store the stabilizing power by switching between the thirteen operating conditions according to the charging/discharging upper limit, the charging/discharging lower limit, the charging power, and the discharging power comprises:
when the integrated energy storage module is in the first operating condition, acquiring a first stored power amount of the first energy storage element charged at the charging power and a first remaining power amount of the second energy storage element discharged at the discharging power; if the first stored power amount reaches the charging/discharging upper limit, the integrated energy storage module switching to the second operating condition; and if the first remaining power amount reaches the charging/discharging lower limit, the integrated energy storage module switching to the third operating condition;
when the integrated energy storage module is in the second operating condition, acquiring a second stored power amount of the third energy storage element charged at the charging power and a second remaining power amount of the second energy storage element discharged at the discharging power; if the second stored power amount reaches the charging/discharging upper limit, the integrated energy storage module switching to the fifth operating condition; and if the second remaining power amount reaches the charging/discharging lower limit, the integrated energy storage module switching to the fourth operating condition;
when the integrated energy storage module is in the third operating condition, acquiring a third stored power amount of the first energy storage element charged at the charging power and a third remaining power amount of the third energy storage element discharged at the discharging power; if the third stored power amount reaches the charging/discharging upper limit, the integrated energy storage module switching to the sixth operating condition; and if the third remaining power amount reaches the charging/discharging lower limit, the integrated energy storage module switching to the seventh operating condition;
when the integrated energy storage module is in the fourth operating condition, acquiring a fourth stored power amount of the third energy storage element charged at the charging power and a fourth remaining power amount of the first energy storage element discharged at the discharging power; if the fourth stored power amount reaches the charging/discharging upper limit, the integrated energy storage module switching to the fifth operating condition; and if the fourth remaining power amount reaches the charging/discharging lower limit, the integrated energy storage module switching to the eighth operating condition;
when the integrated energy storage module is in the fifth operating condition, acquiring a fifth stored power amount of the second energy storage element charged at the charging power and a fifth remaining power amount of the first energy storage element discharged at the discharging power; if the fifth stored power amount reaches the charging/discharging upper limit, the integrated energy storage module switching to the ninth operating condition; and if the fifth remaining power amount reaches the charging/discharging lower limit, the integrated energy storage module switching to the eighth operating condition;
when the integrated energy storage module is in the sixth operating condition, acquiring a sixth stored power amount of the second energy storage element charged at the charging power and a sixth remaining power amount of the third energy storage element discharged at the discharging power; if the sixth stored power amount reaches the charging/discharging upper limit, the integrated energy storage module switching to the tenth operating condition; and if the sixth remaining power amount reaches the charging/discharging lower limit, the integrated energy storage module switching to the seventh operating condition;
when the integrated energy storage module is in the seventh operating condition, acquiring a seventh stored power amount of the second energy storage element charged at the charging power and a seventh remaining power amount of the first energy storage element discharged at the discharging power; if the seventh stored power amount reaches the charging/discharging upper limit, the integrated energy storage module switching to the tenth operating condition; and if the seventh remaining power amount reaches the charging/discharging lower limit, the integrated energy storage module switching to the eleventh operating condition;
when the integrated energy storage module is in the eighth operating condition, acquiring an eighth stored power amount of the second energy storage element charged at the charging power and an eighth remaining power amount of the third energy storage element discharged at the discharging power; if the eighth stored power amount reaches the charging/discharging upper limit, the integrated energy storage module switching to the ninth operating condition; and if the eighth remaining power amount reaches the charging/discharging lower limit, the integrated energy storage module switching to the twelfth operating condition;
when the integrated energy storage module is in the ninth operating condition, acquiring a ninth stored power amount of the first energy storage element charged at the charging power and a ninth remaining power amount of the third energy storage element discharged at the discharging power; if the ninth stored power amount reaches the charging/discharging upper limit, the integrated energy storage module switching to the second operating condition; and if the ninth remaining power amount reaches the charging/discharging lower limit, the integrated energy storage module switching to the twelfth operating condition;
when the integrated energy storage module is in the tenth operating condition, acquiring a tenth stored power amount of the third energy storage element charged at the charging power and a tenth remaining power amount of the first energy storage element discharged at the discharging power; if the tenth stored power amount reaches the charging/discharging upper limit, the integrated energy storage module switching to the thirteenth operating condition; and if the tenth remaining power amount reaches the charging/discharging lower limit, the integrated energy storage module switching to the eleventh operating condition;
when the integrated energy storage module is in the eleventh operating condition, acquiring an eleventh remaining power amount of the second energy storage element discharged at the discharging power and an eleventh stored power amount of the third energy storage element charged at the discharging power; if the eleventh remaining power amount reaches the charging/discharging lower limit, the integrated energy storage module switching to the third operating condition; and if the eleventh stored power amount reaches the charging/discharging upper limit, the integrated energy storage module switching to the thirteenth operating condition;
when the integrated energy storage module is in the twelfth operating condition, acquiring a twelfth stored power amount of the first energy storage element charged at the charging power and a twelfth remaining power amount of the second energy storage element discharged at the discharging power; if the twelfth stored power amount reaches the charging/discharging upper limit, the integrated energy storage module switching to the second operating condition; and if the twelfth remaining power amount reaches the charging/discharging lower limit, the integrated energy storage module switching to the fourth operating condition; and
when the integrated energy storage module is in the thirteenth operating condition, acquiring a thirteenth stored power amount of the first energy storage element charged at the charging power and a thirteenth remaining power amount of the second energy storage element discharged at the discharging power; if the thirteenth stored power amount reaches the charging/discharging upper limit, the integrated energy storage module switching to the sixth operating condition; and if the thirteenth remaining power amount reaches the charging/discharging lower limit, the integrated energy storage module switching to the third operating condition.

13. The terminal device according to claim 10, wherein content of the first-order modal decomposition calculation rule comprises:
performing a calculation based on the power data set and the total power of generation by using a first residual operator formula, to obtain the first-order modal component; and
taking the first-order modal component as the initial energy storage power;
the first residual operator formula being:
$${P}_{IMF 1} = {P}_{w} - \frac{1}{I} {\sum }_{i = 1}^{I} M ( {P}_{w} + {w}_{i} ) , i = 1 , 2 , ⋯ , I$$
where P_{IMF1} denotes the first-order modal component, P_{w} denotes the total power of generation, wᵢ denotes the i^{th} Gaussian white noise, M(*) denotes a residual operator, and/denotes a total quantity of Gaussian white noises.

14. The terminal device according to claim 10, wherein content of the k^{th} modal decomposition calculation rule comprises:
performing empirical modal decomposition on the total power of generation according to the modal decomposition order, to obtain an order residual corresponding to the modal decomposition order;
adding the I Gaussian white noises to the order residual to construct a residual data set comprising I pieces of data;
performing a calculation based on the residual data set and a k−1^{th} order residual by using a second residual operator formula, to obtain the order modal component; and
performing a calculation based on all the order modal components by using an energy storage power calculation formula, to obtain energy storage power of first k orders;
the second residual operator formula being:
$${P}_{IMFk} = {P}_{RESk - 1} - \frac{1}{I} {\sum }_{i = 1}^{I} M ( {P}_{RESk} + {w}_{i} ) ;$$
and
the energy storage power calculation formula being:
$${P}_{BESS} = {P}_{IMF 1} + {P}_{IMF 2} + ⋯ + {P}_{IMFk}$$
where P_{IMFk} denotes a k^{th}-order order modal component, P_{RESk} denotes a k^{th}-order order residual, wᵢ denotes the i^{th} Gaussian white noise, M(*) denotes a residual operator, I denotes a total quantity of Gaussian white noises, and P_{BESS} denotes the energy storage power of the first k orders.

15. The terminal device to claim 10, wherein the grid-connected power mathematical model comprises a power expression and a fluctuation rate expression, the power expression being:
$${P}_{g} ( t ) = {\sum }_{l = 1}^{n} {P}_{wl} ( t ) + {P}_{BESS} ( t ) ;$$
and
the fluctuation rate expression being:
$${P}_{1} ( t ) = [ max {P}_{g} ( a ) - min {P}_{g} ( b ) ] / {P}_{w , rate}$$
$$a , b = t - 60 / {k}_{t} , t - ( 60 - {k}_{t} ) / {k}_{t} , … , t ;$$
$$and$$
$${P}_{10} ( t ) = [ max {P}_{g} ( a ) - min {P}_{g} ( b ) ] / {P}_{w , rate}$$
$$a , b = t - 600 / {k}_{t} , t - ( 600 - {k}_{t} ) / {k}_{t} , … , t$$
where P_{g}(t) denotes grid-connected power at time t, P_{wl}(t) denotes power outputted by an l^{th} generator unit at time t, P_{BESS}(t) denotes energy storage power at time t, n denotes a total number of generator units in the integrated energy storage system of new energy power transmission, P₁(t) denotes a fluctuation rate at a 1-min time scale at time t, P₁₀(t) denotes a fluctuation rate at a 10-min time scale at time t, P_{w, rate} denotes an installed capacity of a power plant in the integrated energy storage system of new energy power transmission, kₜ denotes a sampling interval, and a and b both denote sampling time.

16. The terminal device to claim 10, wherein the constraint condition is P₁∈[0, 1/10] and P₁₀∈[0, ⅓], P₁ being a fluctuation rate at a 1-min time scale, and P₁₀ being a fluctuation rate at a 10-min time scale.
